(19) United States
(12) Patent Application Publication
(10) Pub. No.: US 2010/0009865 A1
(43) Pub. Date: Jan. 14, 2010

(54) OLIGONUCLEOTIDE ARRAYS

(75) Inventors: Piet Herdewijn, Wezemaal (BE); Arthur Van Aerschot, Heist-op-den-Berg (BE); Mikhail Abramov, Heverlee (BE)

Correspondence Address: CLARK & ELBING LLP, 101 FEDERAL STREET, BOSTON, MA, 02110, US

(73) Assignee: KATHOLIEKE UNIVERSITEIT LEUVEN, Leuven (BE)

(21) Appl. No.: 12/443,098

(22) PCT Filed: Oct. 1, 2007
(86) PCT No.: PCT/BE07/00111

§ 371 Date: Mar. 26, 2009

(30) Foreign Application Priority Data
Sep. 29, 2006 (GB) 0619182.9

(51) Int. Cl. C40B 30/04; C40B 50/18

(52) U.S. Cl. 506/9; 506/17; 506/32

(57) ABSTRACT

The present invention provides for oligonucleotide arrays wherein the oligonucleotides comprise six-membered sugar-ring nucleosides, especially tetrahydropyran nucleosides, more specifically altritol nucleosides. The present invention also provides for the use of said oligonucleotide arrays for detecting target molecules in samples (diagnostic or experimental use). The present invention also provides for a method of detecting target molecules in samples by using said oligonucleotide arrays comprising six-membered sugar-ring nucleosides.

### FIELD OF THE INVENTION

The present invention provides for oligonucleotide arrays wherein the oligonucleotides comprise six-membered sugar-ring nucleosides, especially tetrahydropyran nucleosides, more specifically altritol nucleosides. The present invention also provides for the use of said oligonucleotide arrays for detecting target molecules in samples (diagnostic or experimental use). The present invention also provides for a method of detecting target molecules in samples by using said oligonucleotide arrays comprising six-membered sugar-ring nucleosides.

The present invention furthermore provides for a method of preparing oligonucleotide arrays with a controllable amount of oligonucelotides on the surface, and to a method to control the coupling of oligonucleotides to a surface.

The present invention also relates to novel altritol oligonucleotide building blocks and to the use of said novel building blocks. The present invention also relates to a method for the preparation of said novel oligonucleotide building blocks. The present invention also relates to the oligoncucleotides prepared by using said novel oligonucleotide building blocks. Furthermore, the present invention relates to a method for the preparation of oligonucleotides, comprising the use of Fmoc-protected oligonucleotide building blocks, more in particular Fmoc-protected nucleoside phosphoramidites.

### BACKGROUND OF THE INVENTION

In the past years, DNA microarray technology has become a fundamental tool for the detection and analysis of sequence information of nucleic acid. Major applications of this technology include studying gene expression profiles and the detection of single nucleotide polymorphisms (SNPs). DNA microarray products that utilize optical, electrochemical and mechanical detection methods have been developed (Watson, A. et al. Curr. Opin. Biotechnol. 1998, 9, 609-614; Fodor, S. A. et al. Science, 1991, 251, 767-773; Schena, M. et al. Science, 1995, 270, 467-470; Guo, Z. et al. Genome Res., 2002, 12, 447-457). Because of the favorable optical characteristics, DNA chips are in general fabricated using an activated glass slide. The simplest binding mechanism is electrostatic adsorption, for example onto polylysine-coated or aminosilane-modified slides (Eisen, M. B. et al. Methods Enzymol. 1999, 14, 179-205; Burns, N. L. Et al. Langmuir 1995, 11, 2768-2776). Another approach is a modification of glass surface with chemically active groups for covalent arraying of functionalized oligonucleotides. A number surface/oligonucleotide combinations have been successfully introduced (Epstein, J. R. et al. J. Am. Chem. Soc. 2003, 125, 13753-13759; Nonglaton, G. et al. J. Am. Chem. Soc. 2004, 126, 1497-1502; Kimura, N. et al. Nucleic Acids Res. 2004, 32, e68; Schofield, W. C. et al. J. Am. Chem. Soc. 2006, 128, 2280-2285; Situma, C. et al. Anal Biochem. 2005, 340, 123-135), for example thiol/acrylamide as described in WO0116372, carboxylic acid/amine (Beier, M. et al. Nucleic Acids Res. 1999, 27, 1970-1977; Demers, L. M. et al. Angew. Chem., Int. Ed. 2001, 40, 3071-3073), amine/aldehyde (Guschin, D. et al. Anal. Biochem. 1997, 250, 203-211; WO0142495; MacBeath, G. et al. Science 2000, 289, 1760-1763), cycloaddition reactions (Latham-Timmons, H. A. et al. Nucleosides Nucleotides Nucleic Acids, 2003, 22, 1495-1497; Graham, D. et al. Current Organic Synthesis, 2006, 3, 9-17; WO 0184234).

To create arrays, synthetic oligonucleotides or PCR products are usually spotted onto a functionalized glass surface (Heise, C. et al. Topics In Current Chemistry, 2005, 1-25; Lockart, D. J. et al. Nature 2000, 405, 827-836; Schena, M. et al. Science, 1995, 270, 467-70).

The methods used have however several problems. One problem includes that the amount of oligonucleotides coupled to a certain surface can not be controlled and subsequently yields an overloading (or underloading) of oligonucleotides on the surface. Furthermore, unfortunately, natural oligonucleotides (DNA or RNA) don't have the necessary chemical and nuclease stability to obtain durable microarrays that can be reused over a long time period. Often, they show moderate affinity for complementary nucleic acid targets and sometimes oligonucleotide array design gets complicated. Recently, LNA-modified probes for single nucleotide polymorphism genotyping has been reported (Thomsen, R. et al. RNA, 2005, 11, 1745-8; Castoldi, M. et al. RNA, 2006, 12, 913-20).

Another problem coupled to the use of oligonucleotide arrays, is that the loading with oligonucleotides of the surfaces of the oligonucleotide array is crucial to obtain good sensitivities for detection of molecules in samples. Modulation of the oligonucleotide loading of the surfaces has not been described until now for the Diels-Alder cycloaddition coupling of oligonucleotides. The present invention provides a solution to the problem of low sensitivity by providing a method for the modulation of the oligonucleotide loading of the surfaces.

Furthermore, also the synthesis of oligonucleotides in general, but especially of modified oligonucleotides and especially in bulk quatities is still a problematic process. The selection of appropriate protecting groups is a critical issue in successful solid-phase oligonucleotide synthesis. In view of its potential interest as therapeutic or diagnostic agents, the synthesis and physicochemical properties of (4′-6′) altritol nucleic acids (ANA) has been described in the prior art (B. Allart et al. Chem. Eur. J. 1999, 5, 2424-2431). However, the synthetic problems associated with the need to protect the additional 3′-hydroxyl group of altritol nucleosides for oligonucleotide synthesis has slowed down the further development of ANA. The difficulties involved during oligonucleotide synthesis can be summarized as follows. Firstly, there is the potential of forming undesired (3′-6′) internucleotide bonds, usually resulting from the incorporation of isomerically impure nucleoside phosphoramidites. Secondly, the 3′-protecting group must be stable through all stages of oligonucleotide synthesis, and conditions for the deprotection of the oligonucleotides should not cause base modification, migration of the phosphate linkage, or oligonucleotide degradation. Lastly, the deprotected oligonucleotide should be of sufficient purity to allow biochemical assays. The problems in ANA chemical synthesis have been largely overcome by the use of benzoyl protecting groups for the 3′-hydroxylgroup. The use of the benzoyl group in combination with the phosphoramidite method has led to the synthesis of ANA oligonucleotides (B. Allart et al. Chem. Eur. J. 1999, 5, 2424-2431). However, the problem of 3′→4′ benzoyl migration during synthesis of the protected building blocks (B. Allart et al. Tetrahedron, 1999, 55, 6527-6546) results in difficulties for the large scale preparation of isomerically pure phosphoramidites. Subsequently, the application of 3′-O-TBDMS protecting group in ANA oligonucleotide synthesis was investigated (M. Abramov et al. Nucleosides, Nucleotides and Nucleic Acids 2004, 23, 439-455). Although RNA can be produced using this process, the deprotection steps were much more difficult for preparation of ANA sequences than for RNA sequences. As a rule, additional reaction time is required for all steps of ANA synthesis. Steric hindrance in the ANA amidites, as of the axial TBDMS group requires longer coupling times which increase the formation of side products. Base deprotection with ammonia needs longer reaction time, which might cause internucleotide cleavage. Desilylation with TBAF is very sensitive to water and produced salts that must be removed prior to analysis. Triethylamine trihydrogen fluoride (TEA-3HF) has been used as an alternative to TBAF, but was likewise not successful in several cases. Problems with ANA synthesis of base modification, migration of the phosphate linkage, and degradation have been observed by HRMS analysis.

The present invention provides for a solution to the problem associated with the synthesis of oligonucleotides comprising modified nucleosides such as ANA.

### SUMMARY OF THE INVENTION

It has surprisingly been found that oligonucleotide arrays with ANA or HNA oligonucleotides yield a very high discrimination between single mutations in nucleic acid sequences. Therefore, one aspect of the present invention relates to oligonucleotide arrays comprising oligonucleotides coupled to a surface, wherein said the oligonucleotides comprise six-membered sugar-ring nucleosides or nucleotides. A second aspect provides for the use of said oligonucleotide arrays comprising six-membered sugar-ring nucleosides or nucleotides for detecting or analysing molecules in samples (diagnostic or experimental use), such as for nucleic acid sequencing, gene expression profiling, genotyping such as for single nucleotide polymorphism analysis (SNP) or detection of mutations and ligand-target interaction experiments. Another aspect of the present invention also provides for a method for detecting or analysing target molecules in samples by using said oligonucleotide arrays comprising oligonucleotides with six-membered sugar-ring nucleosides or nucleotides.

In a particular embodiment, the six-membered ring is a derivative of tetrahydropyran or tetrahydrothiopyran. In a preferred embodiment of all aspects of the invention, the six-membered sugar-ring nucleosides present in the oligonucleotides coupled to a surface (oligonucleotide array) are selected from altritol comprising nucleosides (as in ANA), 3′-O-alkylated altritol comprising nucleosides or hexitol comprising nucleosides (as in HNA). In a more particular embodiment, the oligonucleotides of the oligonucleotide array comprise only one six-membered sugar-ring nucleoside (more particularly ANA building block), yet more in particular maximally two or three six-membered sugar-ring nucleosides (more particularly ANA building block).

In a preferred embodiment of the present invention, at least one oligonucleotides of the oligonucleotide array is selected from ANA or HNA. In another preferred embodiment of the present invention, the majority, more in particular 80% to 90% of the oligonucleotides of the oligonucleotide array is selected from ANA or HNA. In yet another preferred embodiment of the present invention, all oligonucleotides of the oligonucleotide array are selected from ANA or HNA.

In a particular embodiment, the oligonucleotides of the oligonucleotide array comprise maximally 20 nucleotides, preferably, maximally 15 nucleotides, more preferably between 8 and 14 nucleotides, yet more particularly have between 10 and 12 nucleotides.

In another embodiment of all aspects of the invention, the target molecules (=molecules to be detected) by the oligonucleotide array are biomolecules selected from nucleic acids (DNA, RNA) and proteins and the samples are samples taken from the environment (water, air, etc), microorganisms (such as bacteria, viruses, etc) or animals including mammals, more in particular humans. If nucleic acids in samples are to be detected they can be obtained from a genome of an eukaryote organism, a prokaryote organism or microorganisms in general such as viruses present within the samples taken, in a particular embodiment taken from humans or animals to be diagnosed. In an embodiment, the target nucleic acids are from human or animal origin and are genomic nucleic acids, mitochondrial nucleic acids, nucleic acid found in other cellular organelles or extracellular nucleic acids. In another embodiment, the nucleic acids to be detected are nucleic acids from non-human or non-mammal origin present in samples taken from humans or animals, more in particular being nucleic acids from a microorganism, still more in particular being from a virus such as HIV (human immunodeficiency virus), HCV (hepatitis C virus), influeanza virus, HBV (hepatitis B virus) or other viruses. In yet another more particular embodiment, the target nucleic acids are nucleic acids encoding viral proteins, yet more in particular encoding the protease enzyme, reverse transcriptase enzyme, the integrase enzyme or others. In a particular embodiment, the nucleic acids to be detected are the nucleic acids encoding the HIV protease, the HIV reverse transcriptase or the HIV integrase.

In yet another embodiment, the target nucleic acids are RNA, more in particular are microRNA. In another embodiment of all aspects of the invention, the oligonucleotide arrays as described herein have a low density, namely a density lower than 10¹² cm⁻², more in particular lower than 10¹¹ cm⁻², yet more particularly lower than 10¹⁰ cm⁻².

An aspect of the present invention relates to a (diagnostic) method for the detection of nucleic acids outside the human or animal body in samples taken from a human or animal, said method comprising the use of oligonucleotide arrays wherein the oligonucleotides of said arrays comprise six-membered sugar-ring nucleosides, more in particular tetrahydropyran nucleosides. An embodiment of this aspect relates to the method for the detection of target molecules as described herein for nucleic acid sequencing, gene expression profiling, genotyping such as for single nucleotide polymorphism analysis (SNP) or detection of mutations, ligand-target interaction experiments and for the detection or genetic profiling of microorganisms, preferably viruses. In a particular embodiment, the method serves to detect mutations or SNPs in nucleic acids from microorganisms, more in particular from viruses, yet more in particular for HIV. In another embodiment, the present invention relates to a method for the detection or analysis (outside the human or animal body) of infections by microorganisms in samples taken from humans or animals, said method comprising the use of oligonucleotide arrays, said arrays comprising oligonucleotides with six-membered sugar-ring nucleosides, more in particular comprising oligonucleotides selected from ANA or HNA.

In another particular embodiment, the present invention relates to a method for detecting RNA in samples by using oligonucleotide arrays, wherein said oligonucleotide arrays comprise oligonucleotides which comprise at least one ANA building block. In a more preferred embodiment, the present invention relates to a method for detecting RNA in samples by using oligonucleotide arrays, wherein said oligonucleotide arrays comprise ANA, more specifically are for 100% ANA. In a particular embodiment, said target RNA is microRNAs (miRNA). In yet another particular embodiment, the present invention relates to a method for detecting RNA in samples by using oligonucleotide arrays, wherein said oligonucleotide arrays comprises ANA oligonucleotides and whereby the hybridization and washing temperature is above 30° C., more in particular is between 30° C. and 70° C. or between 30 and 50° C., or is between 30° C. and 40° C. or is 37° C.

A particular embodiment relates to a method for detecting the presence of or analysing target molecules in a sample comprising (i) providing a sample suspected to contain the target molecule, (ii) providing an ANA or an ANA comprising oligonucleotide array wherein at least one ANA is essentially complementary to a part or all of the target molecule, (iii) optionally amplifying the target molecule or preparing the sample for allowing detection such as with extractions, purifications, etc., (iv) contacting the ANA or an ANA comprising oligonucleotide array with the sample under conditions allowing binding of the target molecule to the ANA (in a particular embodiment at temperatures between 30° C. and 70° C.) and (v) detecting the degree of binding or hybridization of ANA to the target molecule in the sample as a measure of the presence, absence or amount of the target molecule in the sample. In the case the target molecule is a nucleic acid, the amplification step can comprise the use of template-dependent polymerases and primers.

More in particular, the present invention relates to a method for the detection of single nucleotide polymorphisms in a target nucleic acids in a sample comprising (i) providing a sample with the target nucleic acid to be analysed, (ii) providing an oligonucleotide array according to the invention wherein at least one oligonucelotide is essentially complementary to a part or all of the target nucleic acid, (iii) optionally amplifying the target molecule or preparing the sample for allowing detection such as with extractions, purifications, etc., (iv) contacting the oligonucleotide array with the sample under conditions allowing binding or hybridization of the target molecule to the oligonucelotides (in a particular embodiment at temperatures between 30° C. and 70° C.) and (v) detecting the degree of binding or hybridization of the oligonucleotides to the target nucleic acid in the sample as a measure of the presence of SNPs in the target nucleic acid in the sample.

The present invention also relates to the use of the oligonucleotide arrays as described herein with all embodiments thereof for nucleic acid sequencing, gene expression profiling, genotyping such as for single nucleotide polymorphism analysis (SNP) or detection of mutations, ligand-target interaction experiments and for the detection or genetic profiling of microorganisms. A preferred embodiment of this aspect relates to the use of ANA oligonucleotide arrays for the genetic profiling of viruses, more in particular HIV. A yet more preferred embodiment relates to the profiling of viral proteins such as protease, reverse transcriptase, polymerase, or integrase, yet more in particular from HIV.

In a particular embodiment, the oligonucleotide arrays, methods and uses of the present invention exclude the presence or use of intercalating nucleic acids such as described in WO2004/065625 or excludes the presence or use of labeled pyrimidine or purine bases as described in EP1466919.

Another aspect of the present invention provides for a method of preparing oligonucleotide arrays with a controllable amount of oligonucleotides (“oligonucleotide loading”) on the surface, and to a method to control the amount of oligonucleotide that will attach to a surface, especially for loading of a surface with oligonucleotides with the Diels-Alder cycloaddition reaction. In this way low-density arrays which give higher hybridization signals can easily be created. Said method comprises contacting a dienophile-alkene or -alkyne modified surface, respectively a diene-modified surface, with a composition comprising a diene-modified oligonucleotide and further comprising a free diene, respectively a composition comprising a dienophile-alkene or -alkyne-modified oligonucleotide and a free dienophile-alkene or -alkyne. A further step of the method comprises allowing the surface to react with the composition under conditions allowing the reaction to take place, more in particular Diels-Alder cyclo-addition conditions.

Another aspect of the present invention relates to a composition comprising a diene-modified oligonucleotide and further comprising a free diene, in a ratio ranging from 5:95 free diene:diene-modified oligonucleotide to 95:5 free diene:diene-modified oligonucleotide. In a yet more particular embodiment, the composition comprises between 5 and 10%, 20%, 30%, 40%, 50%, 60, 70%, 80% or 90% free diene. Alternatively, the present invention relates to a composition comprising a dienophile-alkene or -alkyne-modified oligonucleotide and further comprising a free dienophile-alkene or -alkyne, in a ratio ranging from 5:95 free dienophile-alkene or alkyne: dienophile-alkene or alkyne-modified oligonucleotide to 95:5 free dienophile-alkene or alkyne:dienophile-alkene or alkyne-modified oligonucleotide. In a yet more particular embodiment, the composition comprises between 5 and 10%, 20%, 30%, 40%, 50%, 60, 70%, 80% or 90% free dienophile-alkene or alkyne. In a partiuclar embodiment, the ratio of free diene, respectively free dienophile-alkyne or -alkene, and diene-modified oligonucleotide, respectively dienophile-alkyne or -alkene-modified oligonucleotide is between 20:80 and 40:60, more in particular between 25:75 and 35:65, yet more in particular is 30:70. In particular embodiments, the ratio free diene:diene-modified oligonucleotide, respectively dienophile:dienophile-modified oligonucleotide ranges between 30%:70% to 95%:5%. In another particular embodiment, the free diene used in said compositions is a cyclohexadiene, more in particular is 5-hydroxymethylcyclohexa-1,3-diene.

Another aspect of the invention relates to the use of said compositions of free diene:diene-modified oligonucleotide, respectively dienophile:dienophile-modified oligonucleotide, for the production of oligonucleotide arrays, more in particular with a controllable amount of oligonucleotides (oligonucleotide loading) on the surface with the Diels-Alder cycloaddition recation. Another aspect of the present invention relates to oligonucleotide arrays obtained or obtainable by reacting a dienophile modified surface with a mixture of diene-alkene or -alkyne-modified oligonucleotide and a free diene-alkene or -alkyne, in a ratio ranging from 5:95 free diene-alkene or alkyne:diene-alkene or alkyne-modified oligonucleotide to 95:5 free diene-alkene or alkyne:diene-alkene or alkyne-modified oligonucleotide. In a particular embodiment of this aspect, said mixture comprises maximally 70% diene-alkene or -alkyne-modified oligonucleotide. Alternatively, the present invention relates to oligonucleotide arrays obtained or obtainable by reacting a diene modified surface with a mixture of dienophile-alkene or -alkyne-modified oligonucleotide and a free dienophile-alkene or -alkyne, in a ratio ranging from 5:95 free dienophile-alkene or alkyne:dienophile-alkene or alkyne-modified oligonucleotide to 95:5 free dienophile-alkene or alkyne:dienophile-alkene or alkyne-modified oligonucleotide. In a particular embodiment of this aspect, said mixture comprises maximally 70% dienophile-alkene or -alkyne-modified oligonucleotide.

Another aspect of the invention relates to a kit of parts containing (i) a diene-modified oligonucleotide, respectively dienophile-modified oligonucleotide, (ii) a diene, respectively a dienophile, and optionally (iii) a dienophile, respectively dien-modified surface. This would allow the user to create oligonucleotides with a loading as required by the user.

Yet another aspect of the present invention relates to novel oligonucleotides and to the use of said novel oligonucleotides. In particular, the present invention relates to oligonucleotides being coupled at their 3′ or 5′-end to a diene or dienophile-alkene or -alkyne. More in particular, the present invention relates to oligonucleotides comprising a six-membered sugar-ring nucleoside and being coupled at its 3′ or 5′-end to a diene or dienophile-alkene or -alkyne. The present invention also relates to the use of said novel oligonucleotides for the preparation of oligonucleotide arrays.

Yet another aspect of the present invention relates to novel oligonucleotide building blocks (nucleosides or nucleotides) and to the use of said novel building blocks. The present invention also relates to a method for the preparation of said novel oligonucleotide building blocks. The present invention also relates to the oligoncucleotides prepared by using said novel oligonucleotide building blocks. Furthermore, the present invention relates to a method for the preparation of oligonucleotides, comprising the use of said novel building blocks,.

Said novel oligonucleotide building blocks are Fmoc-protected oligonucleotide building blocks and Fmoc-protected nucleoside phosphoramidites. More in particular, the Fmoc protected oligonucleotide building blocks or Fmoc-protected nucleosides or nucleotides are Fmoc-protected ANA phosphoramidite building blocks, characterised in that the 3′-OH group of the altritol is Fmoc-protected.

According to an embodiment of the invention, the present invention relates to the compounds according to formula II, and salts and (stereo-)isomers thereof,

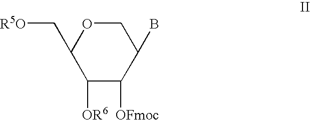

wherein
B is selected from a Fmoc-protected or non-protected pyrimidine or purine base, (if Fmoc-protected, mono- or diprotection of free groups is possible);
R⁵ is selected from hydrogen; a protecting group; a phosphate group; a phosphoramidate group; or taken together with R⁶ forms a 6-membered R⁷-substituted ring;
R⁶ is selected from hydrogen; a phosphoramidite group; or when taken together with R⁵ forms a 6-membered R⁷-substituted ring;
R⁷ is selected from alkyl or aryl, wherein said alkyl or aryl can be substituted or unsubstituted.

In a particular embodiment, B is selected from aden-9-yl; thymin-1-yl; uracil-1-yl; cytosin-1-yl; 5-Me-cytosin-1-yl; guanin-9-yl; diaminopurin-9-yl; N⁶-Fmoc-adenin9-yl; N⁶-(bis)Fmoc-adenin-9-yl; N²-Fmoc-guanin-9-yl; N², O⁶-(bis)Fmoc-guanin-9-yl; N⁴-Fmoc-cytosin-1-yl; or N⁴-Fmoc, 5-Me-cytosin-1-yl.

In another particular embodiment, R⁵ is hydrogen. In another particular embodiment, the protecting group for R⁵ is selected from an acid labile protecting group, yet more in particular is a TFA labile protecting group, still more particularly is selected from trityl or monomethoxytrityl.

In another particular embodiment, R⁶ is hydrogen. In another particular embodiment, R⁶ is a phosphoramidite as commonly used in oligonucleotide synthesis, more in particular is diisopropyl-phosphoramidite mono-(2-cyano-ethyl) ester.

In another particular embodiment, R⁵ and R⁶ are taken together and form a 6-membered R⁷-substituted ring, wherein R⁷ is phenyl.

In a more particular embodiment, the compounds of the invention are according to the formulas below

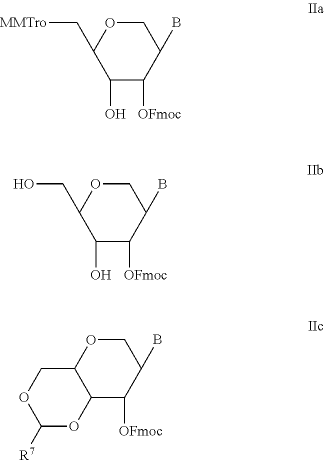

wherein B and R⁷ are as for formula II.

In yet another embodiment, the compounds of the invention are Fmoc-protected altritol (or D-altro-hexitol)phosphoramidites, yet more in particular according to formula IId:

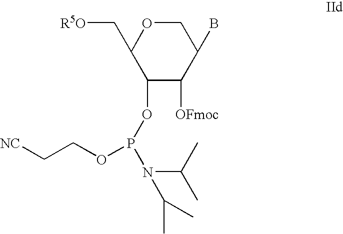

wherein B is as for formula 11 and R⁵ is selected from hydrogen; a protecting group (more in particular an acid labile protecting group, yet more in particular is a TFA labile protecting group, still more particularly is selected from trityl or monomethoxytrityl); a phosphate group; or a phosphoramidate group.

The present invention relates to a method for the production of the compounds of formula II, said method comprising the steps of
(i) reaction a purine or pyrimidine base with 1,5:2,3-dianhydro4,6-O-arylidene-D-allitol or 1,5:2,3-dianhydro4,6-O-alkylidene-D-allitol (in a particular embodiment with 1,5:2,3-dianhydro4,6-O-benzylidene-D-allitol) with a suitable base (in a particular embodiment sodiumhydride, Lithiumhydride, DBU and the like as commonly used for this chemistry);
(ii) Fmoc-protection of the free amino-groups of the purine or pyrimidine base if present and the 3′-free hydroxy-groups of altritol of the reaction product of step (i), in a particular embodiment by addition of Fmoc-Cl in pyridine;
(iii) optionally in order to obtain the 4′-OH, 6′-OH, 3′-FmocO-altritol compounds of the invention, removal of the arylidene or alkylidine protecting group of the reaction product of step (ii) (in a particular embodiment for removal of the benzilidene protecting group, yet more in particular with TFA in dichloromethane);
(iv) optionally in order to obtain the 6′-O-protected altritol compounds of the invention, protecting the 6′-OH group of the reaction product of step (iii), in a particular embodiment by protection with an acid labile protecting group, more in particular with trityl (Tr) or monomethoxytrityl (MMTr);
(v) optionally in order to obtain phosphoramidites, phosphytilation of the reaction product of step (iv), in a particular embodiment by reacting the reaction product of step (iv) with CEPA.

Depending on the purine or pyrimidine base used, this method may comprise additional steps as described herein for example for cytosine, wherein the starting material consisted of the thymin reaction product of step (i) and is than converted to the cytosin adduct by use of 1,2,4-triazolyl activation and substitution with ammonia.

### BRIEF DESCRIPTION OF THE FIGURES OF THE INVENTION

FIG. 1: Structures of modified oligonucleotides with hexitol 1 and altritol 2 sugar rings (a) and arrays (b)

FIG. 2. Melting profiles of perfect/mismatched double stranded oligonucleotides; protease gene (codon 10, 36, and 54), reverse transcriptase gene (codon 74).

FIG. 3. Examples of hybridization of fluorescent labeled 12 mer complimentary and mutated DNA with HNA arrays (A) in comparison with DNA arrays (B). Image A: 1) codon 54 (A*-G mutation); 2) codon 74 (T*-G) mutation; 3) codon 36 (G*-A mutation); 3) control samples: Cy-3 labeled DNA and Cy-3 labeled dieno-modified HNA. Image B: 1) codon 54 (A*-G mutation); 2) codon 74 (T*-G) mutation; 3) codon 36 (G*-A mutation); 3) control samples: Cy-3 labeled DNA and Cy-3 labeled dieno-modified DNA.

FIG. 4. Examples of hybridization of fluorescent labeled 12 mer complimentary and mutated DNA with HNA arrays (A) in comparison with DNA arrays (B) for the codon 10 of protease gen: 1) (C*-G mutation); 2) (C#-T mutation); 3) (C*-G and C#-T mutations); 4) control samples: Cy-3 labeled DNA and Cy-3 labeled dieno-modified DNA.

FIG. 5. Comparing the average fluorescence intensity and fluorescent image of duplex yield for DNA 12 mer wild (Cy5 labeled) and mutated (Cy 3 labeled) sequences of codon 10 and 36 HIV-1 protease gen and of codon 74 HIV-1 reverse transcriptase gen (Table 1) with 12 mer DNA (D), HNA (H), and ANA (A) arrays, and background (BG) noise.

FIG. 6. Comparing the average fluorescence intensity and fluorescent image of duplex yield for DNA and RNA 12 mer wild (Cy5 labeled) and mutated (C→G*, Cy 3 labeled) sequences of codon 10 HIV-1 protease gen (Table 1) with 12 mer DNA (D), HNA (H), and ANA (A) arrays, and background (BG) noise. First row of the image display loading of arrays on the glass surface using Diels-Alder reaction (Cy3 labeled diene-modified DNA, green spot) and background noise as a result of non specific interaction of oligonucleotides (mix of Cy3 and Cy5 labeled 12 mer DNA without diene modification). Right column showing discrimination of an C→G* mutation and sensitivity of DNA, HNA and ANA arrays (from top to bottom) for RNA probes in comparison with DNA probes (left column). HNA and ANA arrays display increased sensitivity and discrimination for DNA and RNA detection

FIG. 7. Comparing the average fluorescence intensity and fluorescent image of duplex yield for DNA and RNA 12 mer wild (Cy5 labeled) and mutated (C→G*, Cy 3 labeled) sequences of codon 74 HIV-1 reverse transcriptase gen (Table 1) with 12 mer DNA (D), HNA (H), and ANA (A) arrays, and background (BG) noise. First row of the image display loading of arrays on the glass surface using Diels-Alder reaction (Cy3 labeled diene-modified DNA, green spot) and background noise as a result of non specific interaction of oligonucleotides (mix of Cy3 and Cy5 labeled 12 mer DNA without diene modification). Right column showing discrimination of an A→G* mutation and sensitivity of DNA, HNA and ANA arrays (from top to bottom) for RNA probes in comparison with DNA probes (left column). HNA and ANA arrays display increased sensitivity and discrimination for DNA and RNA detection.

FIG. 8. Comparing the average fluorescence intensity of duplex yield for DNA and RNA 12 mer wild (Cy5 labeled) and mutated (C→G*, Cy 3 labeled) sequences of codon 10 HIV-1protease gen and codon 74 HIV-1 reverse transcriptase gen (Table 1) with 12 mer DNA (D), HNA (H), and ANA (A) arrays, and background (BG) noise. ANA arrays display dramatically increased sensitivity and discrimination for RNA detection in comparison with DNA arrays when hybridization temperature increases to 37° C.

FIG. 9: structures of the constructs used in the experiments for the controllable loading of oligonucleotides on surfaces.

FIG. 10. Fluorescent image of duplex yield depends on composition of spotting solution. Spots in lower field of the image correspond the immobilization of 5′-Cy3-Diene-GAG ACA ACG GGT-3′ on surface and spots in upper field show the yield of duplexes depend on contents of diene spacer in spotting solution (in 0:100, 10:90, 30:70 and 50:50 molar proportion from left to right).

FIG. 11. Structure of arrays synthesized to study the dependence of duplex yield on composition of spotting solution.

FIG. 12. Structure of amidites 1a-7a with altritol sugar moiety (B is A^{Fmoc2} (1a); G^{Fmoc2} (2a); G^{dmf} (3a); T (4a), U (5a); C^{Fmoc} (6a) or ^{Me}C^{Fmoc} (7a)

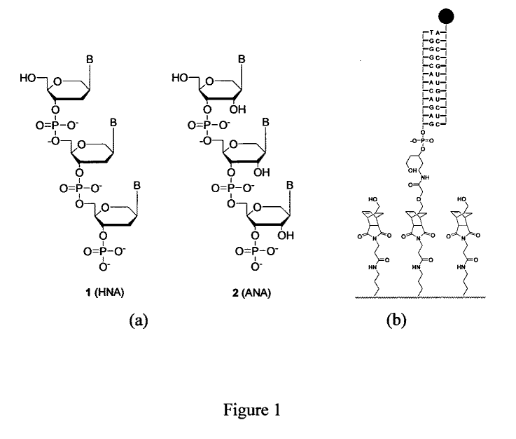

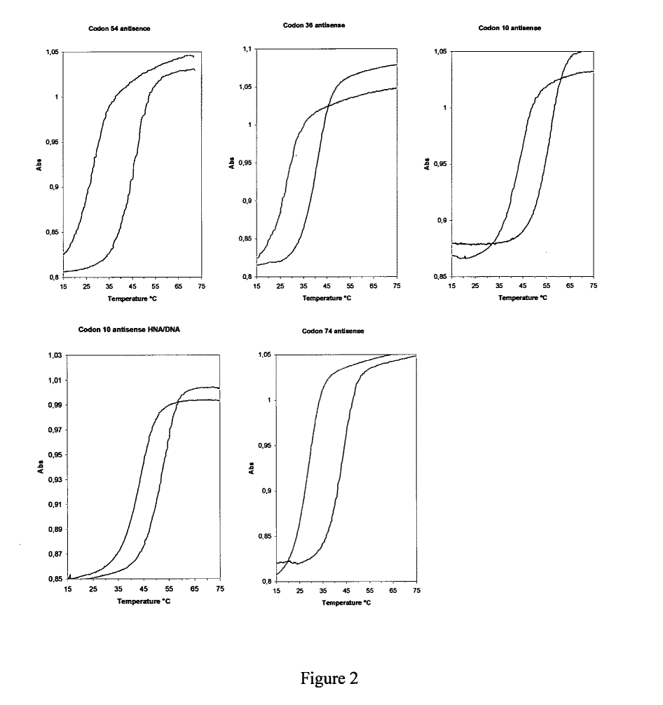

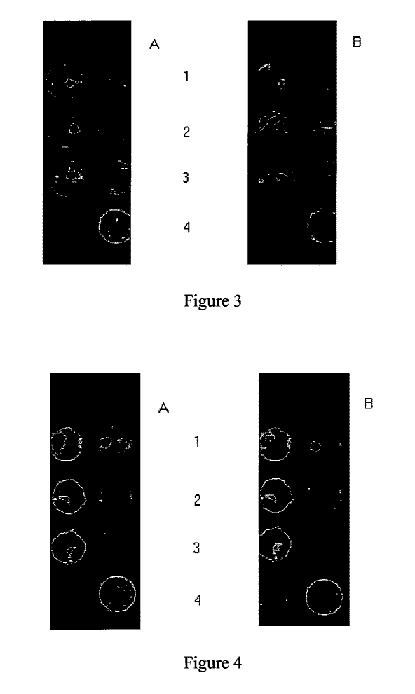

### DETAILED DESCRIPTION OF THE INVENTION

It has been shown previously that the use of modified oligonucleotides comprising six-membered sugar-ring nucleosides, such as HNA, CeNA and ANA show improved chemo- and biostability. The present invention now shows that the use of tetrahydropyran nucleosides in oligonucleotide arrays give a much better selectivity of hybridization, compared to natural DNA, allowing better detection of single nucleotide polymorphisms for example.

The term “six-membered sugar-ring nucleosides” or “six membered sugar-ring nucleotides” in the context of this invention relates to nucleosides or nucleotides respectively which have a 6-membered ring in stead of the natural furanose ring, more in particular have a tetrahydropyran ring in stead of the sugar-ring. In a particular embodiment, the 6-membered ring is a 1,5-anhydrohexitol ring. In a particular embodiment, the 6-membered sugar-ring comprising nucleoside or nucleotide is a substituted or unsubstituted 1,5-anhydrohexitol nucleoside analogue, wherein the 1,5-anhydrohexitol is coupled via its 2-position to a heterocyclic ring, more specifically a purine or pyrimidine base. In a particular embodiment, the 1,5-anhydrohexitol is substituted at the 3-position, more specifically with R³ as defined herein. In certain embodiments, the 6-membered nucleosides or nucleotides are of the formula I (and salts and isomers thereof),

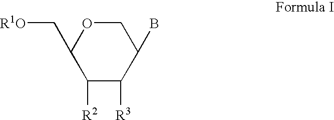

wherein
B is a substituted or unsubstituted heterocyclic ring (more in particular of a pyrimidine or purine base);
R¹ is independently selected from H, an internucleotide linkage to an adjacent nucleotide or a terminal group;
R² is independently selected from phosphate or any modification known for nucleotides to replace the phosphate group,from an internucleotide linkage to an adjacent nucleotide or a terminal group;
R³ is independently selected from H, aklyl, alkenyl, alkynyl, azido, F, Cl, I, substituted or unsubstituted amino, OR⁴, SR⁴, aroyl, alkanoyl or any substituent known for modified nucleotides;
R⁴ is selected from hydrogen; alkyl; alkenyl; alkynyl; cycloalkyl; cycloalkenyl; cycloalkynyl; aryl; arylalkyl; heterocyclic ring; heterocyclic ring-alkyl; acyloxyalkyl; wherein said alkyl, alkenyl and alkynyl can contain one or more heteroatoms in or at the end of the hydrocarbon chain, said heteroatom selected from O, S and N.

In a particular embodiment, R³ is hydrogen. In another particular embodiment, R³ is OH. Thus, in a particular embodiment, the 6-membered ring containing nucleoside or nucleotide is a hexitol or an altritol nucleoside or nucleotide as referred to in EP0646125 or WO02/18406. In a yet preferred embodiment, the 6-membered ring containing nucleoside or nucleotide is according to formula I hereinabove, wherein R³ is selected from OR⁴. In yet another particular embodiment, R⁴ is selected from alkyl, more particularly from C₁₋₇ alkyl, yet more specifically is methyl. Thereby, in a preferred embodiment of this invention, the 6-membered sugar surrogate containing nucleotide is an alkylated altritol nucleotide or nucleoside.

In another embodiment, the 6-membered ring containing nucleoside/nucleotide is selected from the formulas Ia, Ib and Ic hereunder

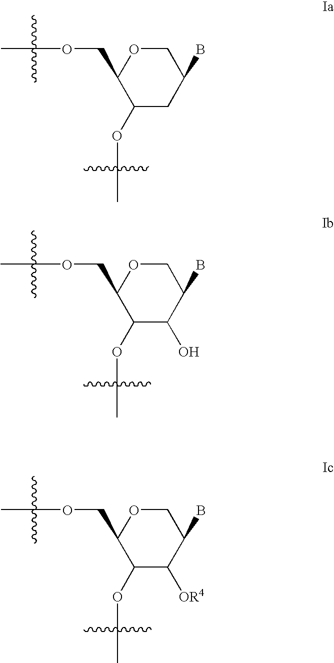

wherein B and R⁴ are as herein described.

In a particular embodiment, the hexitol of the 1,5-anhydrohexitol nucleoside analogues has the D-configuration. In another particular embodiment, the B, R² and R³ of the 1,5-anhydrohexitol nucleoside analogues have the (S)-configuration.

In another embodiment, the 6-membered ring containing nucleoside/nucleotide is selected from the formulas Id, Ie and If hereunder.

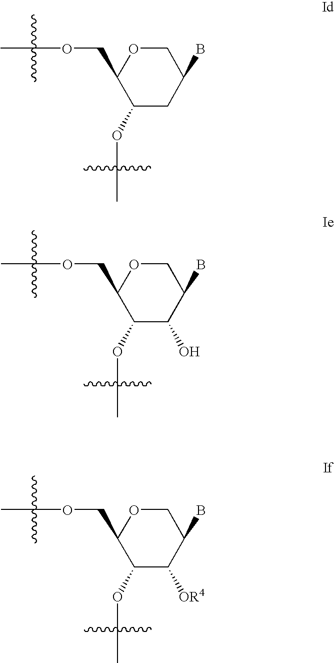

In yet another particular embodiment, the “six-membered sugar-ring nucleosides or nucleotides” are cyclohexenyl comprising nucleotide or nucleoside as described in Wang, J. Et al. J. Am. Chem. Soc. 2000, 122, 8595-6002.

In another particular embodiment of the invention, B is selected from the group consisting of pyrimidine and purine bases; and in a yet more particular embodiment is selected from adenine, thymine, cysteine, uracil, guanine and diaminopurine.

The term “internucleotide linkage” refers to the linkages as known in the art between neighbouring nucleosides, such as the linkage present in natural DNA or RNA, namely a phosphate linkage, or such as modified linkages known in the art such as phosphoramidates, thiophosphates and others.

In this respect, the terms “ANA” and “HNA” are regularly used. They refer respectively to altritol nucleic acids or altritol oligonucleotides (ANA) and hexitol nucleic acids or hexitol oligonucleotides (HNA), meaning nucleic acids or oligonucleotides which comprise for 100% altritol comprising (or alkylated altritol) nucleosides or nucleotides (in the case of ANA) or for 100% hexitol comprising nucleotides or nucleosides (in the case of HNA). With “ANA building blocks” or “altritol nucleotide” at one side or “HNA building blocks” or “hexitol nucleotide” respectively, reference is made to altritol or alkylated altritol nucleotide building blocks (for example with methyl, ethyl or propyl as alkyl on 3′-OH) and to hexitol nucleotide building blocks (more in particular phosphoramidites), meaning a nucleotide wherein the ribose or deoxyribose sugar ring is modified in a six-membered atritol, 3′-O-alkylated altritol or hexitol respectively. (for references for synthesis or use for oligonucleotide synthesis see EP0646125, WO02/18406 and U.S. application Ser. No. 10/362,660 which are incorporated herein by reference.

The term “oligonucleotide” as used herein refers to a polynucleotide formed by a plurality of linked nucleotide units. The nucleotide units each include a nucleoside unit linked together via a phosphate linking group. These nucleotides can be modified in their phosphate, sugar or nucleobase group. The term oligonucleotide also refers to a plurality of nucleotides that are linked together via linkages other than phosphate linkages such as phosphorothioate linkages. The oligonucleotide may be naturally occurring or non naturally occurring. In a preferred embodiment the oligonucleotides of this invention have between 1 and 10000, more in particular between 1 and 1000, yet more in particular between 1 and 100 nucleotides.

For the purposes of this invention “nucleobase” refers to a purine or a pyrimidine base. Nucleobase includes all purines and pyrimidines currently known to those skilled in the art or any chemical modifications thereof.

The term “oligonucleotide array” as used herein refers to a surface coated with nucleic acids or oligonucleotides such as DNA or RNA or modified oligonucleotides such as in the present invention. An example of an oligonucloetide array is a “DNA chip” or “DNA microarray”, also commonly known as gene or genome chip, or gene array. They are a collection of microscopic DNA spots attached to a solid surface, such as glass, plastic or silicon chip forming an array for the purpose of for example expression profiling, monitoring expression levels for thousands of genes simultaneously. The affixed DNA segments are known as probes, thousands of which can be used in a single DNA microarray.

As used herein, and unless stated otherwise, the term “furanose” refers to five-membered cyclic monosaccharides and, by extension, to their sulfur analogues. The numbering of monosaccharides starts at the carbon next to the oxygen inclosed in the ring and is indicated with a prime (′).

A “diene” is defined as a molecule bearing two conjugated double bonds. The diene may even be non-conjugated, if the geometry of the molecule is constrained so as to facilitate a cycloaddition reaction (Cookson (1964) J. Chem. Soc. 5416). The atoms forming these double bonds can be carbon or a heteroatom or any combination thereof.

A “dienophile” is defined as a molecule bearing an (i) alkene group, or a double bond between a carbon and a heteroatom, or a double bond between two heteroatoms or (ii) an alkyne group. The dienophile can be any group, including but not limited to, a substituted or unsubstituted alkene, or a substituted or unsubstituted alkyne. Typically, the dienophile is a substituted alkene of the formula C═C—W or W′—C═C—W, wherein W and W′ are electron withdrawing groups usually being carbonyl containing or cyano containing groups such as CHO, COR, COOH, COCl, COaryl, CN or also NO₂ and others. In certain cases the groups attached to the alkene unit can be electron donating groups. In a particular embodiment, the dienophile is restricted to such dienophiles which are susceptible to a Diels-Alder cycloaddition reaction.

As used herein a “support” or “surface” refers in the context of this invention to glass, including but not limited to controlled pore glass (CPG), glass slides, glass fibers, glass disks, materials coated with glass, silicon chips and wafers including, but not limited to metals and composites containing glass; polymers/resins, including but not limited to polystyrene (PS), polyethylene glycol (PEG), copolymers of PS and PEG, copolymers of polyacrylamide and PEG, copolymers containing maleimide or maleic anhydride, polyvinyl alcohol and non-immunogenic high molecular weight compounds; and large biomolecules, including but not limited to polysaccharides, such as cellulose, proteins and nucleic acids. The support can be, but is not necessarily, a solid support. The support can also refer to other materials than glass such as gold. In a particular embodiment, the surface is the surface of a nucleic acid or oligonucleotide array.

As used herein “immobilization” or “coupling” refers to the attachment, via covalent bond, to a support or surface, wherein mostly the support or surface carries functionalities to attach to.

The term “molecule” or “target molecule” includes, but is not limited to biomolecules or small molecules. As used herein “biomolecules” include, but are not limited to nucleic acids, oligonucleotides, proteins (including antibodies), peptides and amino acids, polysaccharides and saccharides, glycoproteins and glycopeptides (in general, glycoconjugates) alkaloids, lipids, hormones, antibodies and metabolites.

As used herein, and unless stated otherwise, the term “pyrimidine and purine bases” include, but are not limited to, adenine, thymine, cytosine, uracyl, guanine and (2,6-)diaminopurine such as may be found in naturally-occurring nucleosides (aden-9-yl; thymin-1-yl; uracil-1-yl; cytosin-1-yl; guanin-9-yl; diaminopurin-9-yl). The term also includes analogues and derivatives thereof. An analogue thereof is a base which mimics such naturally-occurring bases in such a way that its structure (the kinds of atoms present and their arrangement) is similar to the above-listed naturally-occurring bases but is modified by either having additional functional properties with respect to the naturally-occurring bases or lacking certain functional properties of the naturally-occurring bases. Such analogues include, but are not limited to, those derived by replacement of a —CH— moiety by a nitrogen atom (e.g. 5-azapyrimidines such as 5-azacytosine) or vice-versa (e.g. 7-deazapurines, such as 7-deaza-adenine or 7-deazaguanine) or both (e.g. 7-deaza, 8-azapurines). A derivative of naturally-occurring bases, or analogues thereof, is a compound wherein the heterocyclic ring of such bases is substituted with one or more conventional substituents independently selected from the group consisting of halogen, hydroxyl, amino and C₁₋₆ alkyl. Such purine or pyrimidine bases, analogues and derivatives thereof are well known to those skilled in the art.

As used herein, and unless stated otherwise, the term “alkyl” as used herein refers to linear or branched saturated hydrocarbon chains having from 1 to 18 carbon atoms such as, but not limited to, methyl, ethyl, 1-propyl, 2-propyl, 1-butyl, 2-methyl-1-propyl(isopropyl), 2-butyl(sec-butyl), 2-methyl-2-propyl(tert-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, and the like; preferably the alkyl group has from 1 to 8 carbon atoms, more preferably from 1 to 4 carbon atoms.

As used herein, and unless stated otherwise, the term “cycloalkyl” means a monocyclic saturated hydrocarbon monovalent radical having from 3 to 10 carbon atoms, such as for instance cyclopropyl, cyclobutyl, cyclopentyl, cyclohexyl, cycloheptyl, cyclooctyl and the like, or a C₇₋₁₀ polycyclic saturated hydrocarbon monovalent radical having from 7 to 10 carbon atoms such as, for instance, norbornyl, fenchyl, trimethyltricycloheptyl or adamantyl.

As used herein, and unless stated otherwise, the terms “alkenyl” and “cycloalkenyl” refer to linear or branched hydrocarbon chains having from 2 to 18 carbon atoms, respectively cyclic hydrocarbon chains having from 3 to 10 carbon atoms, with at least one ethylenic unsaturation (i.e. a carbon-carbon sp2 double bond) which may be in the cis or trans configuration such as, but not limited to, vinyl (—CH═CH₂), allyl (—CH₂CH═CH₂), cyclopentenyl (—C₅H₇), and 5-hexenyl (—CH₂CH₂CH₂CH₂CH═CH₂).

As used herein, and unless stated otherwise, the terms “alkynyl” and “cycloalkynyl” refer to linear or branched hydrocarbon chains having from 2 to 18 carbon atoms, respectively cyclic hydrocarbon chains having from 3 to 10 carbon atoms, with at least one acetylenic unsaturation (i.e. a carbon-carbon sp triple bond) such as, but are not limited to, ethynyl (—C≡CH), propargyl (—CH₂C≡CH), cyclopropynyl, cyclobutynyl, cyclopentynyl, or cyclohexynyl.

As used herein with respect to a substituting radical, and unless otherwise stated, the term “aryl” designates any mono- or polycyclic aromatic monovalent hydrocarbon radical having from 6 up to 30 carbon atoms such as but not limited to phenyl, naphthyl, anthracenyl, phenantracyl, fluoranthenyl, chrysenyl, pyrenyl, biphenylyl, terphenyl, picenyl, indenyl, biphenyl, indacenyl, benzocyclobutenyl, benzocyclooctenyl and the like, including fused benzo-C₄₋₈ cycloalkyl radicals (the latter being as defined above) such as, for instance, indanyl, tetrahydronaphtyl, fluorenyl and the like, all of the said radicals being optionally substituted with one or more substituents independently selected from the group consisting of halogen, amino, trifluoromethyl, hydroxyl, sulfhydryl and nitro, such as for instance 4-fluorophenyl, 4-chlorophenyl, 3,4-dichlorophenyl, 4-cyanophenyl, 2,6-dichlorophenyl, 2-fluorophenyl, 3-chlorophenyl, 3,5-dichlorophenyl and the like.

As used herein with respect to a substituting group, and unless otherwise stated, the term “heterocyclic ring” or “heterocyclic” means a mono- or polycyclic, saturated or mono-unsaturated or polyunsaturated monovalent hydrocarbon group having from 3 up to 15 carbon atoms and including one or more heteroatoms in one or more heterocyclic rings, each of said rings having from 3 to 10 atoms (and optionally further including. one or more heteroatoms attached to one or more carbon atoms of said ring, for instance in the form of a carbonyl or thiocarbonyl or selenocarbonyl group, and/or to one or more heteroatoms of said ring, for instance in the form of a sulfone, sulfoxide, N-oxide, phosphate, phosphonate or selenium oxide group), each of said heteroatoms being independently selected from the group consisting of nitrogen, oxygen, sulfur, selenium and phosphorus, also including radicals wherein a heterocyclic ring is fused to one or more aromatic hydrocarbon rings for instance in the form of benzo-fused, dibenzo-fused and naphto-fused heterocyclic radicals; within this definition are included heterocyclic groups such as, but not limited to, pyridyl, dihydropyridyl, tetrahydropyridyl(piperidyl), thiazolyl, tetrahydrothienyl, tetrahydrothienyl sulfoxide, furanyl, thienyl, pyrrolyl, pyrazolyl, imidazolyl, tetrazolyl, benzofuranyl, thianaphthalenyl, indolyl, indolenyl, quinolinyl, isoquinolinyl, benzimidazolyl, piperidinyl, 4-piperidonyl, pyrrolidinyl, 2-pyrrolidonyl, pyrrolinyl, tetrahydrofuranyl, bis-tetrahydrofuranyl, tetrahydropyranyl, bis-tetrahydropyranyl, tetrahydroquino-linyl, tetrahydroisoquinolinyl, decahydroquinolinyl, octahydroisoquinolinyl, azocinyl, triazinyl, 6H-1,2,5-thiadiazinyl, 2H,6H-1,5,2-dithiazinyl, thianthrenyl, pyranyl, isobenzofuranyl, chromenyl, xanthenyl, phenoxathinyl, 2H-pyrrolyl, isothiazolyl, isoxazolyl, pyrazinyl, pyridazinyl, indolizinyl, isoindolyl, 3H-indolyl, 1H-indazoly, purinyl, 4H-quinolizinyl, phthalazinyl, naphthyridinyl, quinoxalinyl, quinazolinyl, cinnolinyl, pteridinyl, 4aH-carbazolyl, carbazolyl, β-carbolinyl, phenanthridinyl, acridinyl, pyrimidinyl, phenanthrolinyl, phenazinyl, phenothiazinyl, furazanyl, phenoxazinyl, isochromanyl, chromanyl, imidazolidinyl, imidazolinyl, pyrazolidinyl, pyrazolinyl, piperazinyl, indolinyl, isoindolinyl, quinuclidinyl, morpholinyl, oxazolidinyl, benzotriazolyl, benzisoxazolyl, oxindolyl, benzoxazolinyl, benzothienyl, benzothiazolyl and isatinoyl; heterocyclic groups may be sub-divided into heteroaromatic (or “heteroaryl”) groups such as, but not limited to, pyridyl, dihydropyridyl, pyridazinyl, pyrimidinyl, pyrazinyl, s-triazinyl, oxazolyl, imidazolyl, thiazolyl, isoxazolyl, pyrazolyl, isothiazolyl, furanyl, thiofuranyl, thienyl, and pyrrolyl, and non-aromatic heterocyclic groups; when a heteroatom of the said non-aromatic heterocyclic group is nitrogen, the latter may be substituted with a substituent selected from the group consisting of alkyl, cycloalkyl, aryl, arylalkyl and alkylaryl (such as defined herein); by way of example, carbon-bonded heterocyclic rings may be bonded at position 2, 3, 4, 5, or 6 of a pyridine, at position 3, 4, 5, or 6 of a pyridazine, at position 2, 4, 5, or 6 of a pyrimidine, at position 2, 3, 5, or 6 of a pyrazine, at position 2, 3, 4, or 5 of a furan, tetrahydrofuran, thiofuran, thiophene, pyrrole or tetrahydropyrrole, at position 2, 4, or 5 of an oxazole, imidazole or thiazole, at position 3, 4, or 5 of an isoxazole, pyrazole, or isothiazole, at position 2 or 3 of an aziridine, at position 2, 3, or 4 of an azetidine, at position 2, 3, 4, 5, 6, 7, or 8 of a quinoline or at position 1, 3, 4, 5, 6, 7, or 8 of an isoquinoline; still more specific carbon-bonded heterocycles include 2-pyridyl, 3-pyridyl, 4-pyridyl, 5-pyridyl, 6-pyridyl, 3-pyridazinyl, 4-pyridazinyl, 5-pyridazinyl, 6-pyridazinyl, 2-pyrimidinyl, 4-pyrimidinyl, 5-pyrimidinyl, 6-pyrimidinyl, 2-pyrazinyl, 3-pyrazinyl, 5-pyrazinyl, 6-pyrazinyl, 2-thiazolyl, 4-thiazolyl, or 5-thiazolyl; by way of example, nitrogen-bonded heterocyclic rings may be bonded at position 1 of an aziridine, azetidine, pyrrole, pyrrolidine, 2-pyrroline, 3-pyrroline, imidazole, imidazolidine, 2-imidazoline, 3-imidazoline, pyrazole, pyrazoline, 2-pyrazoline, 3-pyrazoline, piperidine, piperazine, indole, indoline, 1H-indazole, at position 2 of an isoindole or isoindoline, at position 4 of a morpholine, and at position 9 of a carbazole or β-carboline, still more specific nitrogen-bonded heterocycles include 1-aziridyl, 1-azetedyl, 1-pyrrolyl, 1-imidazolyl, 1-pyrazolyl and 1-piperidinyl.

As used herein and unless otherwise stated, the term halogen means any atom selected from the group consisting of fluorine, chlorine, bromine and iodine.

As used herein and unless otherwise stated, the term “anomeric carbon” refers to the carbon atom containing the carbonyl functionality of a sugar molecule, also referred to as a carbohydrate. This carbon atom is involved in the hemiacetal or hemiketal formation characteristic for the sugar ring structure. This carbonyl carbon is referred to as the anomeric carbon because it is non-chiral in the linear structure, and chiral in the cyclic structure.

As used herein and unless otherwise stated, the term “selective protection” and “selective deprotection” refer to the introduction, respectively the removal, of a protecting group on a specific reactive functionality in a molecule containing several functionalities, respectively containing several protected functionalities, and leaving the rest of the molecule unchanged. Many molecules used in the present invention contain more than one reactive functionality. For example carbohydrates are characterised by more than one alcohol functional group. It is often necessary to manipulate only one (or some) of these groups at a time without interfering with the other functionalities. This is only possible by choosing a variety of protecting groups, which can be manipulated using different reaction conditions. The use of protecting groups in such a way that it is possible to modify a functionality independantly from the other functionalities present in the molecule is referred to as “orthogonal protection”. The development of orthogonal protecting group strategies makes it possible to remove one set of protecting groups in any order with reagents and conditions, which do not affect the groups in other sets. An efficient protecting group strategy can be critical for accomplishing the synthesis of large, complex molecules possessing a diverse range of reactive functionality. This protection reaction can be chemoselective when selectivity is due to chemical properties, regioselective when due to the location of the functionality within the molecule. A reaction or transformation can be “stereoselective” in two ways, i.e. (1) because it will only occur at a specific stereoisomer or at a specific stereo-orientation of the functionality, or (2) because it will result in only one specific stereoisomer. A protection reaction can therefore also be stereoselective for example in a way that it will only result in protection of a functionality when in a certain conformation.

Detection fo Match/Mismatch Sequences

The present invention describes new efficient oligonucleotide arrays that utilize HNA and ANA as probes, covalently bonded to (glass) substrate. Application of low density arrays increases the intensity of hybridization signal. Hybridization and discrimination of matched/mismatched base pairing was investigated using fluorescence labeled DNA and RNA targets, hybridized on the DNA, HNA and ANA arrays. Using the ANA arrays and RNA probes a higher discrimination relative to the DNA array/RNA probes combination has been observed.

Hexitol and altritol nucleic acids have been evaluated for their potential to be used as synthetic oligonucleotide arrays for match/mismatch detection of DNA and RNA probes on solid support. Introduction of hexitol and altritol chemistry into array technology enhance the hybridization properties of the classical DNA chemistry versus DNA and RNA probes (although the effect on RNA probes is more significant). The duplex melting temperature increases comparing to DNA arrays. In addition, by using HNA and ANA bases, shorter arrays can be designed to address traditionally problematic target sequences with AT- or GC-rich regions and certain design limitations that cannot be overcome with standard DNA chemistry can be reduced or eliminated. HNA and ANA form less secondary structure than DNA, circumventing problems of sequences limitations for targeting. ANA and DNA sequences keep high M/MM (match/mismatch) discrimination. This discrimination can be easily manipulated by changing the hybridization temperature to obtain clearer readable arrays. Their phosphoramidites and oligomers are easy available and their chemistry is compatible with DNA and RNA chemistry for synthesizing oligonucleotides. HNA and ANA are chemical and enzymatic stable oligonucleotides, which may be beneficial for storage and reuse of the chips. Certainly in the new field of RNA detection, ANA arrays are beneficial.

An example of RNA detection is the detection of microRNAs. MicroRNAs represent a class of short, noncoding regulatory RNAs involved in development, differentiation and metabolism. By using the oligonucleotide arrays according to the invention, single nucleotide differences between closely related miRNA family members can be made. Due to the high sensitivity and discrimination capacity of the arrays, miRNA expression profiling of biological and clinical samples is greatly simplified.

The basis principle underlying the use of oligonucleotide biochips is the discrimination between matched and mismatched duplexes. The efficiency of discrimination depends on a complex set of parameters, such as the position of the mismatch in the probe, the length of the probe, A-T contents and the hybridization conditions. Significant differences may exist in duplex stability depending on the A-T content of the analyzed duplexes on the sequence. The array design become quite complicated when sequences with difference in AT content need to be analyzed. The general approach to equalize the thermal stability of duplexes of different base compositions is using probes of different lengths. The use of HNA and ANA could help in Tm modulation. Central mismatches are easier to detect that terminal ones, shorter probes allow easier match/mismatch discrimination. However, shorter oligonucleotides can lead to the formation of too unstable hybrids for detection, and here use high-affinity RNA-targeted analogs like HNA and ANA may help.

The present invention shows that arrays of oligonucleotides comprising six-membered sugar comprising nucleosides, like HNA and ANA arrays, are an interesting new tool for biotechnology and nucleic acid diagnostics. It has been shown that introduction of hexitol and altritol chemistry into array technology enhances the hybridization properties of the classical DNA chemistry versus DNA and RNA probes, with surprisingly an even higher effect on RNA probes and certainly in combination with ANA arrays. The duplex melting temperature increases comparing to DNA arrays. In addition, by using HNA and ANA nucleosides, shorter arrays can be designed to address traditionally problematic target sequences with AT- or GC-rich regions and certain design limitations that cannot be overcome with standard DNA chemistry can be reduced or eliminated. HNA and ANA form less secondary structure than DNA circumventing problems of sequences limitations for targeting. ANA and DNA sequences keep high M/MM discrimination. This discrimination can be easily manipulated by changing the hybridization temperature to obtain clearer readable arrays. Their phosphoramidites and oligomers are easy available and their chemistry is compatible with DNA and RNA chemistry for synthesizing oligonucleotides. HNA and ANA are chemical and enzymatic stable oligonucleotides, which may be beneficial for storage and reuse of the chips.

Controllable Loading of Oligonucleotides on Surfaces

The present invention relates to the conditions for the controlled conjugation of diene-modified oligonucleotides, more in particular cyclodiene-modified oligonucleotides on maleoimide-modified glass surface via Diels-Alder cycloaddition. The invention also relates to the methods for determination of the loading of oligonucleotides.

Using the method according to the present invention, namely diluting the dien-modified oligonucleotide with free diene, arrays of low density have been obtained with the intensity of hybridization signal being increased up to 1.7 times compared with arraying of undiluted oligodiene. As an example, lower density arrays were obtained by using 5-hydroxymethylcyclohexa-1,3-diene in the spotting mixture together with the 5′-diene modified oligonucleotides

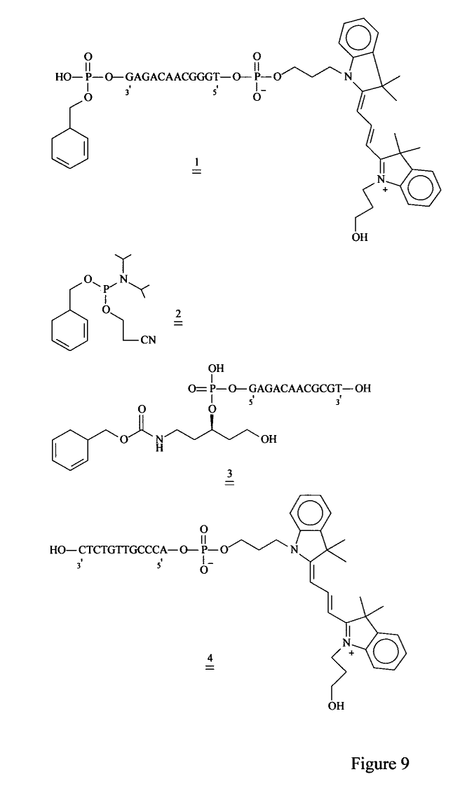

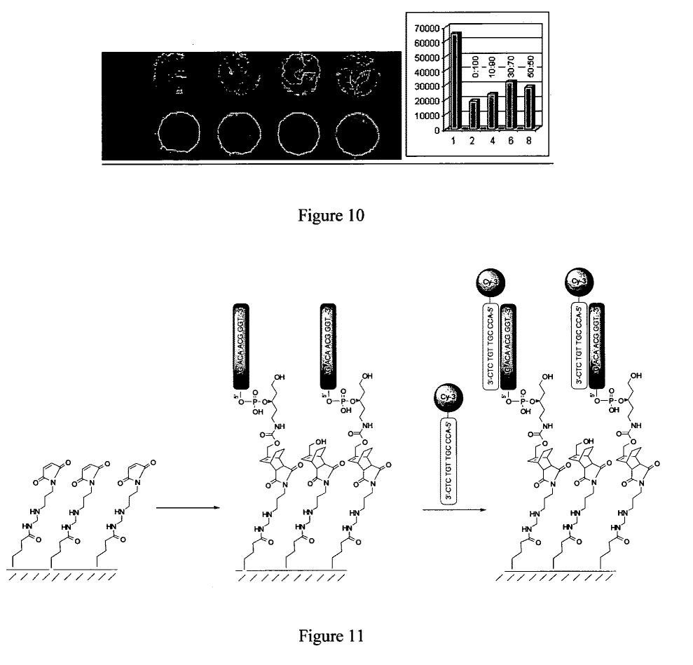

Hybridization signal achieves substantial detection sensitivity near an array surface density as low as 10¹² cm⁻². To ensure that the oligonucleotide single strands are well separated from each other on the glass surface, mixed oligonucleotide arrays were prepared where the density of the oligonucleotide can be controlled. A dienophile modified optically flat glass slide was prepared and reacted with a cyclohexadiene modified Cy-3 labeled 12 mer sequence (FIG. 9-(1)). This modified oligonucleotide was used to investigate reaction circumstances for covalently binding the oligonucleotides on the solid support and as (positive) reference sample for the detection of fluorescence on the glass slide. The structure of the cyclohexadiene phosphoramidite used for 3′-modification is shown in FIG. 9-(2).

The Cy-3 labeled 12 mer sequence without 3′-end modification was synthesized to monitor non specific interaction of the oligonucleotide on the glass surface. The 5′-diene-GAGACAACGGGT (FIG. 9-(3)) and the Cy-3 labeled complement (FIG. 9-(4)) were synthesized to investigate the composition of the spotting mixture needed for detection of hybridization. Lower density arrays were obtained by using 5-hydroxymethylcyclohexa-1,3-diene in the spotting mixture together with the 5′-diene modified oligonucleotides (ratio of 0:100; 10:90; 30:70; 50:50) (FIG. 11). As it follows from green channel scan images, the packing of the undiluted oligonucleotide (ratio 0:100) is too dense to allow duplex formation with the target oligonucleotide. A ratio of free diene/oligodiene of 30:70 is needed for fluorescence detection.

Fmoc-Protected Phosphoramidite Building Blocks for Oligonucleotide Synthesis

The present invention provides a solution to the problematic synthesis of ANA building blocks. It has been shown that by using Fmoc-protected ANA building blocks, the synthesis of ANA comprising oligonucleotides proceeds much better. ANA fully Fmoc protected phosporamidite building blocks were obtained from 1,5:2,3-dianhydro4,6-O-benzylidene-D-allitol. The experiments showed that the introduction of the 3′-O-Fmoc protecting group as well as a Fmoc protection of amino function of adenine and 5-methyl cytosine doesn't need the vigorous reaction conditions. The amino group of guanine base could be Fmoc protected only using TMS transient protection, but dimethylformamidine (dmf) protecting working better. The highly pure Fmoc protected phosphoramidites were obtained using a procedure which yields a much cleaner phosphitylation.

The fully Fmoc protected phosphoramidite building blocks of the altritol nucleotides with adenine, guanine, thymine, uracil, cytosine and 5-methylcytosineas as base moiety have been synthesized. These building blocks were used for the synthesis of altritol nucleic acid (ANA) and chimeric ANA-RNA oligonucleotide. The excellent compatibility with Pac RNA chemistry for synthesis of chimeric oligonucleotides has been proven.

Fmoc as the protecting group can be removed from the protected bases and sugar moieties by aliphatic amines like triethylamine and piperidine, oximate reagent or potassium carbonate in methanol. In addition, Fmoc can be used as protecting group both for the heterocyclic base and the 3′-OH group.

We decided to use 2-cyanoethyl N,N-diisopropylphosphoramidite approach (F. Himmelbach et al. Tetrahedron, 1984, 40, 54-72; S. A. Scaringe et al. Nucleic Acid Res. 1990, 18, 5433-5441) because of its high yield in the internucleotide coupling reaction. The more base labile 2-cyanoethyl phosphate protecting group should be released faster than the Fmoc protecting group, avoiding migration reactions. Moreover, all protecting groups (except of MMTr) can be removed by β-elimination, which makes a one-step final deprotection procedure possible.

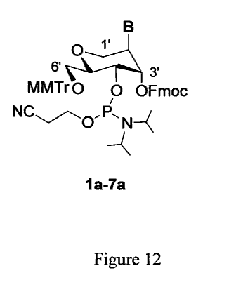

Seven phosphoramidites of D-altritol nucleosides with a 3′-O-(9-fluorenylmethoxycarbonyl) protecting group were synthesized 1a-7a (base moieties are adenine, guanine, uracyl, cytosine, thymine and 5-methylcytosine—FIG. 12) following a new strategy. The nucleosides were obtained by ring opening reaction of 1,5:2,3-dianhydro-4,6-O-benzylidene-D-allitol (M. Abramov et al. Nucleosides, Nucleotides and Nucleic Acids 2004, 23, 439-455). 1,5:2,3-Dianhydro4,6-O-benzylidene-D-allitol was prepared from commercially available tetraacetyl-α-D-bromoglucose in 5 steps (54% overall yield), basically according to the procedure described by Brockway et al. in J. Chem. Soc. Perkin Trans 1, 1984, 875-878.

The advantage of this approach is that a D-altritol nucleoside is obtained with a free 3′-OH group and a protected 4′-OH and 6′-OH group, avoiding problems with the regioselective introduction of a protecting group in the 3′-position. Different conditions were tested for the nucleophilic opening of the epoxide by the salts of nucleobases. As well classical sodium and lithium salts, as a more soft base (DBU) or a phase transfer catalyst like tetrabutylammonium chloride/potassium carbonate could be applied. The preferred reaction conditions proved base dependent.

The fully protected altritol phosphoramidite with an adenine base moiety was obtained in 5 steps. Reaction of the DBU salt of adenine (3 eq) with 1,5:2,3-dianhydro4,6-O-benzylidene-D-allitol in DMF at 90° C. for 6 h yielded 2-(adenin-9-yl)-1,5-anhydro4,6-O-benzylidene-2-deoxy-D-altro-hexitol 1b (Scheme 1) in 70%. One-pot Fmoc protection of the N⁶-amino group of the adenine base and 3′-OH of the hexitol moiety was carried out with Fmoc chloride in pyridine and gave only 1,5-anhydro-2-[N⁶-bis(9-fluorenylmethoxycarbonyl)adenin-9-yl]4,6-0-benzylidene-3-O-(9-fluorenylmethoxycarbonyl)-2-deoxy-D-altro-hexitol 1c in 76% yield. The preparation of 1,5-anhydro-2-[N⁶-(9-fluorenylmethoxycarbonyl)adenin-9-yl]4,6-0-benzylidene-3-O-(9-fluorenylmethoxycarbonyl)-2-deoxy-D-altro-hexitol 1d is slightly complicated. We tested different conditions for the selective removal of one of the two Fmoc groups on the N⁶-amino group (pyridine/water, ammonia/dioxane, triethylamine/dioxane). This resulted either in complete deprotection of hexitol 1c (to 1b) either in partial conversion of 1c into a mixture of 1d and the 3′-OH deprotected compound 1e, in low yield.

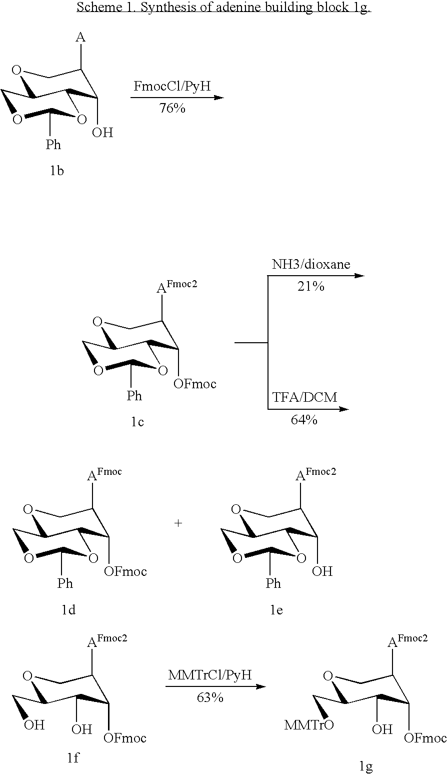

Therefore we kept both Fmoc protecting groups on the adenine base and used 1c in the next step. Removal of the benzylidene protecting group could be done with trifluoroacetic acid in dichloromethane without migration of the 3′-O-Fmoc protecting group (and without formation of a 3′,4′-cyclic carbonate), giving 1f in 64 % yield. Likewise, the 6′-O-monomethoxytrityl group can be introduced under common reaction circumstances (pyridine, room temperature). Synthesis of the A(Fmoc)₃ phosphoramidite 1a was accomplished by phosphitylation of the 3′-O-Fmoc 6′-O-monomethoxytrityl protected building block 1g using (N,N-diisopropylamino)(cyanoethyl)chloroposphoramidite (CEPA) as the phosphitylating agent in dioxane with 2,4,6-collidine as a base and N-methylimidazole as the catalyst.

As could be expected, the guanine congener is a particular case. Previously, we described the epoxide opening using the sodium salt of 2-amino-6-chloropurine in DMF in 40% yield. Besides the major product, two side compounds were identified, i.e. the N⁷-substituted compound and the bis-purinyl nucleoside. The same reaction using the lithium salt of N²-acetyl-2-amino-6-[2-(trimethylsilyl)ethoxy)-purine]afforded the protected guanine nucleoside in 45% yield (after deacetylation). These results are unsatisfactory for large scale synthesis of the altritol nucleosides. The reaction in the presence of aliquat 336/K₂CO₃ in DMF gives 45% of the desired compound together with three side compounds. The additional side compound proved to be the N⁹-substituted 2-amino-4-dimethyl-aminopurine nucleoside. By utilising the same phase transfer catalyst, but in HMPA as solvent, side product formation could be avoided and the desired compound was obtained in 70% yield. Reactions with related bases (guanine and N²-iso-butyrylguanine) did not lead to the correct condensation product.

The 6-chloro-2-aminopurine base was converted into the guanine base yielding 2b (Scheme 2), followed by transient protection procedure, to introduce the N²-Fmoc and 3′-O-Fmoc groups. However, Fmoc protection of 2b did not yield the desired N²,3′-O-bis-Fmoc protected G. Initially, only the 3′-O-Fmoc protected compound was formed in 45% yield. The transient silylation of 2b went to completion after 6 h. When using conditions for transient TMS protection of 2b, a mixture of N²-Fmoc and N²,O⁶-bis(Fmoc) protected compounds was obtained. These two compounds migrate close to each other on TLC and could not be completely separated by large scale silica gel column chromatography. We decided to use the mixture on the next step. After removing TMS with 1N TBAF in THF the mixture of 2c and 2d was obtained in 1:1 ratio as estimated by ¹H NMR. The mixture of 2c and 2d was reacted with 2-fold excess of Fmoc chloride in pyridine which gave exclusively tris-Fmoc protected 2e in a 50% yield based on 2b.

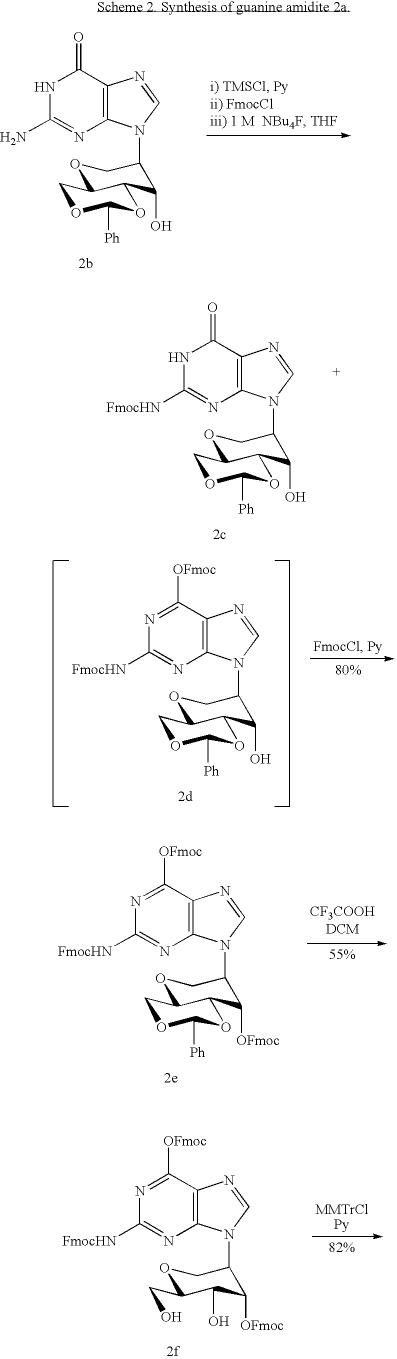

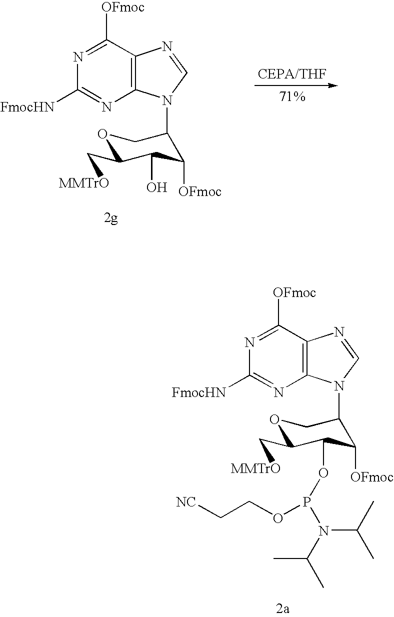

After removal of the benzylidene group, the primary hydroxyl group was protected with monomethoxytrityl chloride. Finally, the phosphoramidite 2a was obtained in 71% yield by phosphitylation of the protected building block 2g using CEPA as the phosphitylating agent and 2,4,6-collidine as a base and N-methylimidazole as catalyst in dioxane.

The G^{dmf} protected phosphoramidite 3a was obtained starting from 2-amino-6-chloropurine which was converted into the guanine base 2b, followed by a classical protection procedure, to introduce the dimethylformamide protecting group on 2-NH₂ affording 3b and the Fmoc group on 3′-OH (Scheme 3).

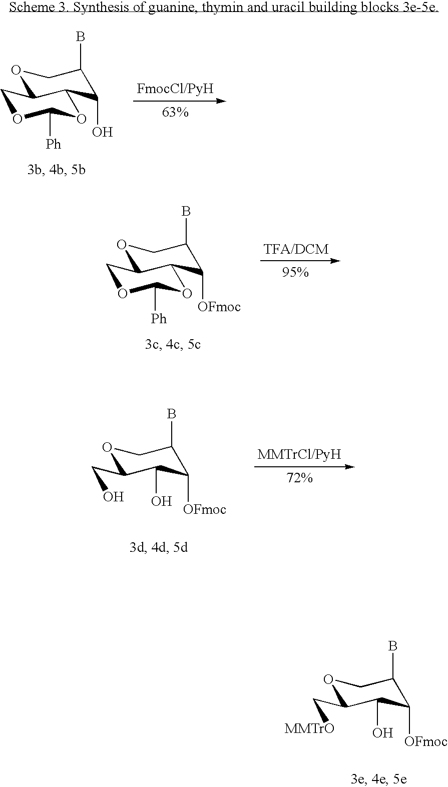

After removal of the benzylidene group, the primary hydroxyl group was protected with monomethoxytrityl chloride yielding 3e. The phosphoramidite 3a was obtained in 71% yield by phosphitylation of the protected building block 3e using the previous described procedure for the Fmoc protected G-building block 2g.

The U and T fully protected altritol phosphoramidite were obtained in 5 steps starting from uracil and thymine (Scheme 3). The DBU salt of bases were reacted with 1,5:2,3-dianhydro4,6-O-benzylidene-D-altritol in DMF at 90° C. for 6 h yielding 94% of 1,5-anhydro4,6-O-benzylidene-2-deoxy-2-(uracyl-1-yl)-D-altro-hexitol 4b^{[1]} and 1,5-anhydro4,6-O-benzylidene-2-deoxy-2-(thymin-1-yl)-D-altro-hexitol 5b.^{[3]} Introduction of the 3′-O-Fmoc protecting group was carried out with Fmoc chloride in pyridine and yielded 4c and 5c, respectively. After removal of the benzylidene protecting group, the primary hydroxyl group was protected with a monomethoxytrityl group. These reactions occur without any problems dealing with protecting group migration from the 3′-O-axial to the 4′-O-equatorial position. Finally, the U(Fmoc) 4a and T(Fmoc) 5a phosphoramidite were obtained by phosphitylation of the 3′-O-Fmoc 6′-O-Monomethoxytrityl protected U 4e and T 5e building block using (N,N-diisopropylamino)(cyanoethyl)chlorophosphoramidite (CEPA) as the phosphitylating agent.

The C (6a) and ^{Me}C (7a) fully protected phosphoramidites were obtained in 6 steps starting from uracil and thymine respectively (Scheme 4). 1,5-Anhydroxy4,6-O-benzylidene-2-deoxy-2-(uracil-1-yl)-D-altro-hexitol 4b and thymine analog 5b were used as starting material for the synthesis of the protected cytosine (6b) and 5-methylcytosine (7b) congener. The method used is 1,2,4-triazolyl activation of the 4-position of the uracil and thymine base, followed by substitution with ammonia to yield 6b and 7b.^{[10]} For all cases investigated, it seems that the conversion of the uracyl and thymine base in the cytosine bases is a better way (higher yield) to obtain the 4-aminopyrimidine nucleosides than the direct opening reaction of the epoxide ring with the salts of the respective nucleobases.

The N⁴-position and 3′-OH are protected with a Fmoc group in one step, followed by benzylidene removal and 6-O-monomethoxytritylation. Finally, the C(Fmoc) and ^{Me}C(Fmoc) phosphoramidite 6a and 7a were obtained in 88% yield by phosphitylation of the protected C 6e and ^{Me}C 7e building block using CEPA.

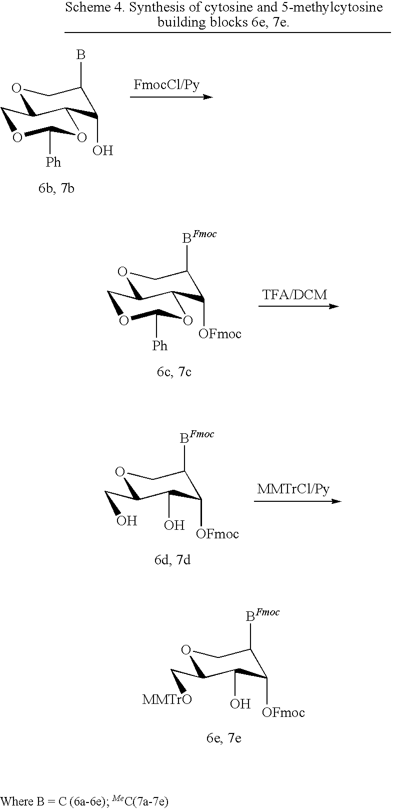

### Examples

The following examples are provided for the purpose of illustrating the present invention and should in no way be interpreted as limiting the scope thereof.

### Example 1

### Materials and Methods For the Production of Arrays and Detection of Match/Mismatch Sequences With Oligonucleotides Comprising Six-Membered Sugar Ring Nucleosides

Materials

Chemicals were of analytical grade and used as received from commercial sources, unless indicated. Reagents for DNA/RNA synthesizer were purchased from Applied Biosystems (Tokyo, Japan) and Glen Research Co. (Sterling, Va., USA). Cyclohexadiene linker (R)—O-cyclohexa-2,4-dienylmethyl-N-{3-[(2-cyanoethoxy)diisopropylaminophosphano]-5-(4-methoxytrityl)}-3-hydroxypentylcarbamate was prepared follow by a known procedure starting from 5-hydroxymethylcyclohexa-1,3-diene (Hill, K. W. et al. J. Org. Chem., 2001, 66, 5352-5358). The 5′-Cy3 and 5′-Cy5 labeled oligoribonucleotides were purchased from Integrated DNA Technologies, Inc (Coralville, Iowa, USA). Glass substrates, hybridization and washing buffers (SMM, UHS, WB1, WB2, and WB3) were purchased from TeleChem International, Inc. (Sunnyvale, Calif., USA).

Synthesis of Oligonucleotides

The synthesis of 5′-Cy3 and 5′-Cy5 labeled and 5′-diene-functionalized oligodeoxyribonucleotides was accomplished by the standard phosphoramidite method on an Exedite synthesizer (Applied Biosystem) in 1.0 μmol scale. The functionalization of oligonucleotides with a diene reagent was achieved by terminal coupling of diene-amidite to a support bond oligonucleotide (Latham-Timmons, H. A. et al. Nucleosides Nucleotides Nucleic Acids, 2003, 22, 1495-1497). Cleavage and deprotection of oligonucleotides were carried out according to the manufacturer's instructions unless otherwise noted. The crude oligonucleotides were desalted on NAP-25 column and purified by anion exchange HPLC. The purity and structure of modified oligonucleotides were confirmed by anion exchange HPLC and HRMS. 5′-Diene-functionalized HNA and ANA were synthesized by the standard phosphoramidite method in 1.0 μmol scale.

Slides, Spotting and Hybridization Conditions

Amino coated glass substrates were functionalized with covalently linked maleimide using maleimidopropionic acid NHS-ester as described (Kusnezow, W. et al. Proteomics 2003, 3, 254-264).
Spotting and immobilization procedure: Diene-functionalized oligonucleotides were dissolved in 0.1 M NaH₂PO₄ (pH 6.5) at 5 pmol/ul concentration and spotted with a 40 ul Pipetteman using SecureSeal™ chambers SA8R-0.5 from Grace Bio-Labs, Inc. (Bend, Oreg., USA). Each slide was once spotted with Cy3-labeled diene-functionalized oligonucleotide to monitor loading of arrays and once with mixture of Cy3 and Cy5-labeled non-functionalized oligonucleotides to monitor non-specific binding of oligonucleotides and to calculate the background for subtraction from average intensity within arrayed spots. The spots were 8 mm in diameter and 13 mm center-to-center. The arrays were maintained at 40° C. around 90% humidity for 2 h and washed with TRIS-buffered saline (pH 8) containing 0.1% Tween 20 and water.
Hybridizations: hybridizations were performed as follows. UniHyb solutions at 5 pmol/ul concentration of two different fluorescently labeled oligonucleotides were applied in the same hybridization chambers and the slide was incubated for 1.5 h at 25° C. in a closed hybridization cassette. Subsequently, the arrays were washed at 10° C. in WB1 and WB2 for 5 min, rinsed briefly in WB3 and dried in a stream of nitrogen.

Scanning and Data Analysis

Slides were scanned using a Generation III scanner (Amersham Biosciences), with wavelength settings at 532 nm (Cy3 signal) and 635 nm (Cy5 signal). Analysis of the intensity of the original 16-bit tiff images from either a Cy3 or a Cy5 channel was performed with ScanAnalyze (Standford Microarray Database [http://genome-www5.stanford.edu]).

and graphs were generated in Microsoft Excel. Unless stated otherwise, the average signal values were taken from three spot areas on two slides processed in parallel. The background calculated within the control spot was subtracted from the average intensity within each arrayed spot.

Also gold surfaces were used for cooupling oligonucleotides in order to prepare oligonucloetide microarrays. For this purpose chemical oxidation of hydroquinone functionalized gold slides was applied, especially with a stream of air. Following, the conjugation of diene-oligonucleotides was performed in general according to the description herein.

### Example 2

### Detection of Match/Mismatch Sequences For Mutant HIV Strains With ANA and/or HNA Comprising Oligonucleotide Arrays

For testing the selectivity and sensitivity of the HNA/ANA arrays (and compare their properties with regular DNA arrays), we selected sequences in the reverse transcriptase gene and the protease gene of HIV-1 where the wild-type and the mutant types of the virus are distinguished by one or two point mutations, which give rise to the generation of drug resistant strains. The selected point mutations are examples of Pu→Pu, Py→Py and Py→Pu interconversions. The Cy-5 and Cy-3 fluorescent dyes were chosen for the labeling of oligonucleotides to monitor the arraying and hybridization of HNA/ANA and DNA oligonucleotides because of these dyes being stable in standard conditions of oligonucleotide synthesis and deprotection, and they can be detected with commercially available microarray scanners.

Although hybridization conditions are different in solution and on solid support, we determined the difference of the thermal stability between the matched and mismatched duplexes for regular double stranded DNA. These DNA probes are 12 mers centered around the mutation site. The destabilization effect is mismatching dependent. For example the T-G mismatch reduces the thermal stability of a dsDNA with 8° C., compared to 13° C. for A-C, 10° C. for C-A and 21° C. for C-C mismatches. The differences, however, are striking and sufficiently pronounced to allow a selective discrimination between mutant gene and wild type gene using DNA probes. Similar data could not be generated with HNA (ANA) probes because these synthetic oligonucleotides tend to form self-hybridized complexes. However, when the oligonucleotides are separated on solid support and oriented in the same direction, this self-hybridization did not influence their use as detection probes. It follows from the melting profiles that the best discrimination for the matched/mismatched detection in solution is situated between 32° C. and 38° C. Taking into account that surface bounding of target oligonucleotides reduce the Tm (up to 7-8° C.) we decided to carry out hybridization experiments at 25° C., and compare the DNA/HNA/ANA probes in the same conditions.

TABLE 1
The sequences and mutation sites (identified by
* or ^{#}) selected for proof of principle

| | |
|---|---|
| | Mutations |
| | present |
| | in mutant |
| Sequence of wild type | type |

Protease gen

| | | |
|---|---|---|
| Codon 10 | 5′-CAGCGACCCC*TC^{#}GTCTCA-3′ | C*→G |
| | | C^{#}→T |
| Codon 36 | 5′-TTAGAAGACATG*AATTG-3′ | G*→A |
| Codon 54 | 5′-GGAGGTTTTA*TCAAAGTA-3′ | A*→G |
| Reverse | | |
| transcriptase | | |
| gen | | |
| Codon 74 | 5′-TGGAGAAAAT*TAGTAGAT-3′ | T*→G |

TABLE 2
5′-Diene functionalized oligonucleotides
synthesized for arraying and UV-melting
point determination of duplexes

| Probe | | |
|---|---|---|
| name | Probe sequences (5′-3′) | Tₘ (° C.)^{a} |
| DNA10 | d(GAGAC [symbol] A [symbol] GGGT) | 56.3 ± 0.2 |
| | | 53.1 ± 05^{b} |
| HNA10 | h(GAGAC [symbol] A [symbol] GGGT) | 52.5 ± 0.1 |
| | | 72.0 ± 0.4^{b} |
| ANA10 | a(GAGAC [symbol] A [symbol] GGGT) | 58.6 ± 0.5 |
| | | 76.7 ± 0.1^{b} |
| DNA36 | d(AAATT [symbol] ATGTCT) | 41.0 ± 0.2 |
| HNA36 | h(AAATT [symbol] ATGTCT) | 52.6 ± 0.5 |
| ANA36 | a(AAATT [symbol] ATGTCT) | —^{c} |
| DNA54 | d(TTTGA [symbol] AAAACC) | 47.1 ± 0.0 |
| HNA54 | h(TTTGA [symbol] AAAACC) | 59.3 ± 0.5 |
| ANA54 | a(TTTGA [symbol] AAAACC) | —^{c} |
| DNA74 | d(CTACTA [symbol] TTTTC) | 44.1 ± 0.1 |
| | | 43.7 ± 0.1^{b} |
| HNA74 | h(CTACTA [symbol] TTTTC) | 52.5 ± 0.5 |
| | | 57.5 ± 0.1^{b} |
| ANA74 | a(CTACTA [symbol] TTTTC) | 57.6 ± 0.2 |

^{a}Tₘ values were measured as the maximum of the first derivative of the melting curve (A₂₆₀ and A₂₇₀ vs. temperature 10 to 85° C. and 85 to 10° C.; increase 1° C. min⁻¹) recorded in medium salt buffer (10 mM sodium phosphate, 100 mM sodium chloride, 0.1 mM EDTA, pH 7.0) using 4 μM concentrations with complimentary 5′-Cy3 DNA.
^{b}Complimentary 5′-Cy5 RNA;
^{c}Tm values could not be measured with some HNA and ANA sequences because these synthetic oligonucleotides tend to form self-hybridized complexes.

All oligonucleotides were synthesized according to standard procedures for solid phase synthesis using phosphoramidite building blocks and a CPG support. The diene group was introduced at the 5′-end of the DNA/HNA/ANA 12 mer sequences that were used for immobilization on solid support. The DNA and RNA matched and mismatched sequences, used as probes to be detected, were synthesized with a Cy-3 label at the 5′-end.

TABLE 3
Melting points of M/MM double strands oligo-
nucleotides; protease gene (codon 10, 36, and
54), reverse transcriptase gene (codon 74).

| | | | |
|---|---|---|---|
| | Tm (° C.) | Tm (° C.) | |
| | with | with | |
| | matched | mismatched | |
| | sense | sense | ΔTm |
| DNA probes | sequence | sequence | (° C.) |

Codon 54 antisense

| | | | | |
|---|---|---|---|---|
| 5′-TTTGACAAAACC-3′ | 47 | G→A | 28 | −19 |
| Codon 36 antisense | | | | |
| 5′-AAATTTAUGTCT-3′ | 41 | A→G | 33 | −8 |
| Codon 10 antisense | | | | |
| 5′-GAGACAACGGGT-3 | 56 | G→C | 35 | −21 |
| | | T→C | 43 | −13 |
| | | G→C and | | −36 |
| | | T→C | | |
| Codon 74 antisense | | | | |
| 5′-CTACTACTTTTC-3′ | 44 | G→T | 29 | −15 |

TABLE 42
The sequences synthesized for proof of principle

| | |
|---|---|
| Diene-modified DNA, HNA (h), ANA (a) | Cy-3 and Cy-5 labeled DNA, RNA (r) |

| | | | Wild type and |
|---|---|---|---|
| N^{o} | antisense sequence | N^{o} | mutated (*) sense sequence |
| 54 | 5′-diene-TTTGACAAAACC-3′ | | 3′-AAACTGTTTTGG-Cy-3-5′ |
| | h-5′-diene-TTTGACAAAACC-3′ | | 3′-AAACTGTTTTGG-Cy-5-5′ |
| | a-5′-diene-TTTGACAAAACC-3′ | | 3′-AAACTA*TTTTGG-Cy-3-5′ |
| 10 | 5′-diene-GAGACAACGGGT-3′ | N^{o} | 3′-CTCTGTTGCCCA-Cy-3-5′ |
| | h-5′-diene-GAGACAACGGGT-3′ | | 3′-CTCTGTTGCCCA-Cy-5-5′ |
| | a-5′-diene-GAGACAACGGGT-3′ | | 3′-CTCTGCTC*CCCA-Cy-3-5′ |
| | | | 3′-CTCTGC*TGCCCA-Cy-3-5′ |
| | | | 3′-CTCTGC*TC*CCCA-Cy-3-5′ |
| | | | r-3′-CUCUGUUGCCCA-Cy-5-5′ |
| | | | r-3′-CUCUGCUC*CCCA-Cy-3-5′ |
| 74 | 5′-diene-CTACTACTTTTC-3′ | N^{o} | 3′-CATGATGAAAAG-Cy-3-5′ |
| | h-5′-diene-CTACTACTTTTC-3′ | | 3′-CATGATGAAAAG-Cy-5-5′ |
| | a-5′-diene-CTACTACTTTTC-3′ | | 3′-CATGATT*AAAAG-Cy-3-5′ |
| | | | r-3′-CAUGAUGAAAAG-Cy-3-5′ |
| | | | r-3′-CAUGAUU*AAAAG-Cy-3-5′ |
| 36 | 5′-diene-AAATTTATGTCT-3′ | | 3′-TTTAAATACAGA-Cy-3-5′ |
| | h-5′-diene-AAATTTATGTCT-3′ | | 3′-TTTAAATACAGA-Cy-5-5′ |
| | a-5′-diene-AAATTTATGTCT-3′ | | 3′-TTTAAG*TACAGA-Cy-3-5′ |

Oligonucleotide hybridization and discrimination of matched/mismatched duplexes was investigated using the Cy-3 labeled DNA probes, hybridized on the 12 mer DNA and HNA arrays. Especially with the HNA array, excellent discrimination of matched/mismatched hybrids is seen, except for the assay for the detection of the codon 36 mutation [where the ΔTm between the stability is only 8° C. and where the Tm of the mismatch sequence (33° C.) is 8° C. higher as the temperature at which the measurement is done (25° C.)].

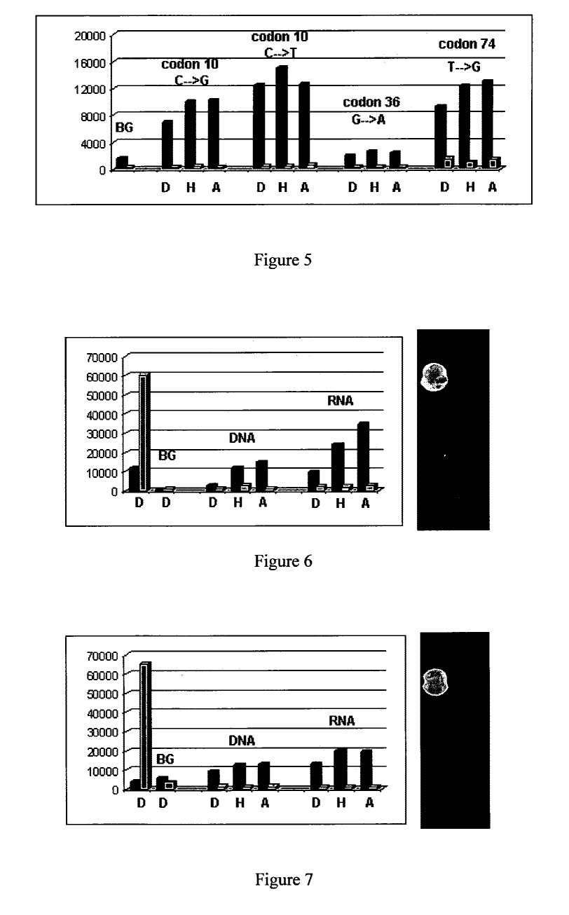

Hybridization results using DNA probes of matched (Cy5 labeled) and mismatched (Cy3 labeled) sequences on DNA, HNA, and ANA arrays (Table 4) are presented in FIG. 5. As expected, in all cases a difference in hybridization signal is evident between the fully matched probes (red or left channel) and one containing a single mismatch with the hybridized target (green or right channel). The intensity of each signal was calculated from three spot areas of wild-type and mutant-type signals respectively. Quantification analysis shows that the intensity of signal of mutant probes as low as background noise and the relative fluorescence intensity between wild-type and mutant specific oligonucleotide probes on each array is high enough to allow single M/MM discrimination and increases substantially when HNA and ANA arrays are used (ANA>HNA>DNA).

The signal intensities obtained after hybridization was found to vary amongst the different probes, even for those that had identical Tₘ's, i. e. some perfectly matched probes produced lower signals than other perfectly matches probes. This property reflects probably differences in the secondary structures of the probes, which are directly depended on the sequence of the probes themselves, and are impossible to predict. Also the different arrays are not optimized in terms of hybridization properties, but performance was consistent with expected properties of DNA duplexes in solution. We found that hexitol and altritol modified oligonucleotides arrayed onto glass slides allowed single M/MM DNA discrimination.

Hybridization results of RNA targets with matched (Cy5 labeled) and mismatched (Cy3 labeled) on DNA, HNA, and ANA arrays (Table 4) are presented in FIGS. 6 and 7. As expected, in all cases a difference in hybridization signal is evident between the fully matched probes (red or left channel) and one containing a single mismatch with the hybridized target (green or right channel).

The intensity of each signal was calculated from three spot areas of wild-type and mutant-type signals respectively. Quantification analysis shows that the intensity of the signal from mutant probes is as low as background noise and the relative fluorescence intensity between wild-type and mutant specific oligonucleotide probes on each array is high enough allow single M/MM discrimination. The intensity of hybridization signals for RNA targets is higher than for DNA targets and increases when applying HNA and ANA arrays (ANA>HNA>DNA).

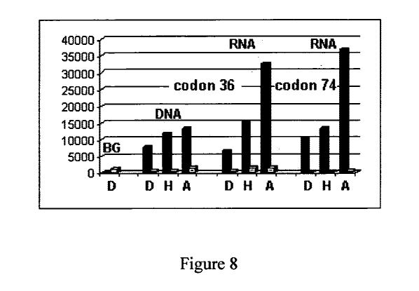

FIG. 8 shows the influence of increasing the hybridization and washing temperature of the slides to 37° C. (other tests were carried out at 25° C.). In the case of DNA targets and DNA and HNA arrays the effect of temperature is moderate. However, the M/MM discrimination of RNA on ANA arrays increased dramatically.

### Example 3

### Controllable Loading of Maleimido-Functionalized Glass Slides For Oligonucleotide Arraying Using Diels-Alder Cycloaddition Reaction and Hybridization

Slides, Spotting and Hybridization Conditions

Amino coated glass substrates were functionalized with covalently linked maleimide using maleimidopropionic acid NHS-ester as described in Kusnezow, W. et al. Proteomics 2003, 3, 254-264.

Spotting and Immobilization Procedure.

Diene-functionalized oligonucleotides were dissolved in 0.1 M NaH₂PO₄ (pH 6.5) at 5 pmol/ul concentration and spotted with a 40 ul Pipetteman using SecureSeal™ chambers SA8R-0.5 from Grace Bio-Labs, Inc. (Bend, Oreg., USA). Each slide was once spotted with Cy3-labeled diene-functionalized oligonucleotide to monitor loading of arrays and once with mixture of Cy3 and Cy5-labeled non-functionalized oligonucleotides to monitor non-specific binding of oligonucleotides and to calculate the background for subtraction from average intensity within arrayed spots. The spots were 8 mm in diameter and 13 mm center-to-center. The arrays were maintained at 40° C. around 90% humidity for 2 h and washed with TRIS-buffered saline (pH 8) containing 0.1 % Tween 20 and water.

Hybridizations

Hybridizations were performed as follows. UniHyb solutions at 5 pmol/ul concentration of two different fluorescently labeled oligonucleotides were applied in the same hybridization chambers and the slide was incubated for 1.5 h at 25° C. in a closed hybridization cassette. Subsequently, the arrays were washed at 10° C. in WB1 and WB2 for 5 min, rinsed briefly in WB3 and dried in a stream of nitrogen.

Scanning and Data Analysis

Slides were scanned using a Generation III scanner (Amersham Biosciences), with wavelength settings at 532 nm (Cy3 signal) and 635 nm (Cy5 signal). Analysis of the intensity of the original 16-bit tiff images from either a Cy3 or a Cy5 channel was performed with ScanAnalyze (Standford Microarray Database [http://genome-www5.stanford.edu]) and graphs were generated in Microsoft Excel. Unless stated otherwise, the average signal values were taken from three spot areas on two slides processed in parallel. The background calculated within the control spot was subtracted from the average intensity within each arrayed spot.

### Example 4

### Synthesis of Fmoc-Protected Phosphoramidite Building Blocks For Oligonucleotide Synthesis

General Materials and Methods

Tetra-O-acetyl-α-D-bromoglucose was provided by Fluka; adenine, cytosine, guanine and uracil were from ACROS. All other chemicals were provided by Aldrich or ACROS and were of the highest quality. ¹H NMR and ¹³C NMR spectra were determined with a 200 MHz Varian Gemini apparatus with tetramethylsilane as internal standard for the ¹H NMR spectra (s=singlet, d=doublet, dd=double doublet, t=triplet, br s=broad signal, br d=broad doublet, m=multiplet) and the solvent signal DMSO-d6 (39.6 ppm) or CDCl₃ (76.9 ppm) for the ¹³C NMR spectra. For some products a Varian Unity-500 spectrometer (500 MHz for ¹H) was used. Coupling constant values were derived by first-order spectral analysis. Exact mass measurements were performed on a quadrupole/orthogonal acceleration time-of-flight tandem mass spectrometer (qTOF2, Micromass, Manchester, UK) equipped with a standard electrospray ionization interface. Precoated Machery-Nagel Alugram SILG/UV₂₅₄ plates were used for TLC, and the spots were examined with UV light and sulfuric acid/anisaldehyde spray. Column chromatography was performed on ACROS silica gel (0.060-0.200 mm or 0.035-0.060 mm). Anhydrous solvents were obtained as follows: dichloromethane was stored over calcium hydride, refluxed and distilled. Pyridine was refluxed over potassium hydroxide pellets and distilled. Dimethylformamide was dried over 4 Å activated molecular sieves. HMPA was dried by azeotropic distillation using toluene. Absolute methanol was refluxed overnight over magnesium iodide and distilled. Methanolic ammonia was prepared by bubbling NH₃ gas through absolute methanol at 0° C. and was stored at −20° C.

### Synthesis of 1,5-anhydro-2-deoxy-3-O-(9-fluorenylmethoxycarbonyl)-2-nucleoside-6-O-mono-methoxytrityl-D-altro-hexitol 3-N,N-diisopropyl(2-cyanoethyl)phosphoramidites 1a-7a

Dry 6-O-(monomethoxytrityl)-3-O-(9-fluorenylmethoxycarbonyl)altro-hexitol N′-(9-fluorenylmethoxycarbonyl) protected nucleoside (1 mmol) was dissolved in dry THF (5 mL). 2,4,6-Collidine (7.5 mmol) was added followed by N-methylimidazole (0.5 mmol). N,N-diisopropylamino(cyanoethyl)phosponamidic chloride (2.5 mmol) was then added dropwise over 5 min at room temperature. The reaction was completed after 1-2 h as determined by TLC. The reaction mixture was diluted with dichloromethane (50 mL) washed with water and dried over Na₂SO₄. The solvent was removed in vacuo yielding a viscous oil. Coevaporation with toluene (2×10 mL) afforded the crude phosphoramidite as an off-white foam or oil. The phosphoramidites were further purified by silica gel chromatography and precipitated from hexane (150 mL) at −60° C. yielding a white fine powder in 75-85% yields.

### 1,5-Anhydro-2-deoxy-3-O-(9-fluorenylmethoxycarbonyl)-2-[N²-bis(9-fluorenylmethoxycarbonyl)-adenin-9-yl]-6-O-monomethoxytrityl-D-altro-hexitol 4-N,N-diisopropyl(2-cyanoethyl)phosphoramidite 1a

³¹P NMR (CDCl₃): 149.75; 152.41. HRMS calcd for C₈₅H₇9N₇O₁₂P (MH)+ 1420.5524, found 1420.5562.

### 1,5-Anhydro-2-deoxy-3-O-(9-fluorenylmethoxycarbonyl)-2-[N²,O⁶-bis(9-fluorenylmethoxycarbonyl)-quanin-9-yl]-6-O-monomethoxytrityl-D-altro-hexitol 4-N,N-diisopropyl(2-cyanoethyl)phosphoramidite 2a

³¹P NMR (CDCl₃): 149.46; 151.59. HRMS calcd for C₈₅H₇₉N₇O₁₃P (MH)+ 1436.5474, found 1436.5537.

### 1,5-Anhydro-2-deoxy-3-O-(9-fluorenylmethoxycarbonyl)-[2-(N²-dimethylaminomethylene)guanin-9-yl]-6-O-monomethoxytrityl-D-altro-hexitol 4-N,N-diisopropyl(2-cyanoethyl)phosphoramidite 3a

³¹P NMR (CDCl₃): 150.9. HRMS calcd for C₅₈H₆₄N₈O₉P (MH)+ 1047.4534, found 1047.4547.

### 1,5-Anhydro-2-deoxy-3-O-(9-fluorenylmethoxycarbonyl)-2-thymin-1 -yl]-6-O-monomethoxytrityl-D-altro-hexitol 4-N,N-diisopropyl(2-cyanoethyl)phosphoramidite 4a

³¹P NMR (CDCl₃): 150.02; 151.93. HRMS calcd for C₅₅H₆₀N₄O₁₀P (MH)+ 967.4047, found 967.4099.

### 1,5-Anhydro-2-deoxy-3-O-(9-fluorenylmethoxycarbonyl)-2-uracil-1 -yl]-6-O-monomethoxytrityl-D-altro-hexitol 4-N,N-diisopropyl(2-cyanoethyl)phosphoramidite 5a

³¹P NMR (CDCl₃): 150.61; 152.63. HRMS calcd for C₅₅H₆₀N₄O₁₀P (MH)+ 967.4047, found 967.4099.

### 1,5-Anhydro-2-deoxy-3-O-(9-fluorenylmethoxycarbonyl)-2-[N⁴-(9-fluorenylmethoxycarbonyl)-cytosin-1-yl]-6-O-monomethoxytrityl-D-altro-hexitol 4-N,N-diisoproyl(2-cyanoethyl) phosphoramidite 6a

³¹P NMR (CDCl₃): 149.50; 151.93. HRMS calcd for C₇₀H₇₁N₅O₁₁P (MH)+ 1188.4888, found 1188.4873.

### 1,5-Anhydro-2-deoxy-3-O-(9-fluorenylmethoxycarbonyl)-2-[N⁴-(9-fluorenylmethoxycarbonyl)-5-methylcytosin-1-yl]-6-O-monomethoxytrityl-D-altro-hexitol 4-N,N-diisopropyl(2-cyanoethyl)phosphoramidite 7a

³¹P NMR (CDCl₃): 150.03; 151.96. HRMS calcd for C₇₀H₇₁N₅_{O}₁₁P (MH)+ 1188.4888, found 1188.4873.

### Synthesis of 1,5-Anhydro-2-deoxy-2-[N⁶-bis(9-fluorenylmethoxycarbonyl)adenin-9-yl]-3-O-9-fluorenylmethoxycarbonyl)-6-O-monomethoxytrityl-D-altro-hexitol 1g

### 1,5-Anhydro-4,6-O-benzylidene-2-deoxy-2-[N⁶-bis(9-fluorenylmethoxy carbonyl)adenin-9-yl]-3-O-(9-fluorenylmethoxycarbonyl)-D-altro-hexitol 1c.

9-Fluorenylmethoxycarbonyl chloride (4.2 g, 16.3 mmol) was added in four portions to a solution of 1b (C. Brockway et al. J. Chem. Soc. Perkin Trans 1, 1984, 875-878) (1.5 g, 4.06 mmol) in dry pyridine (30 mL) under nitrogen and the reaction mixture was stirred at room temperature for 1 h. The reaction was monitored with TLC. Then, MeOH (10 mL) was added and the stirring was continued for 30 min. The yellow solution was evaporated and co-evaporated with toluene (2×30 mL) to dryness. The residue was subjected to silica gel flash column chromatography using 2.5% of acetone in dichloromethane as eluent. Precipitation from dichloromethane-hexane at −60° C. affords the title compound 1c as a white powder (3.2 g, 76%). ¹H-NMR (CDCl₃) δ 3.64 (1H, dd, J=2.6 Hz, J=9.7 Hz, 4′-H); 3.74 (1H, t, J=10.4 Hz, 6′ax-H); 4.10-4.70 (13H, m, 1′-H, 5′-H, 6′eq-H, CH₂O(Fmoc), 9-H (Fmoc)); 5.00 (1H, br s, 2′-H); 5.39 (1H, s, PhCH); 5.72 (1H, br s, 3′-H); 7.19-7.50 (21 H, m, H arom); 7.65 (6H, m, H arom); 7.80 (2H, d, J=7.7 Hz, H arom); 8.55 (1H, s, 8-H); 8.94 (1H, s, 2-H). HRMS calcd for C₆₃H₅₀N₅O₁₀ (MH)+ 1036.3558, found 1036.3553.

### 1,5-Anhydro-4,6-O-benzylidene-2-deoxy-2-[N⁶-(9-fluorenylmethoxy carbonyl)adenin-9-yl]-3-O-(9-fluorenylmethoxycarbonyl)-D-altro-hexitol 1d.

The compound 1c (103 mg, 0.1 mmol) was dissolved in dioxane (2 mL) and ammonia (26%) (500 μL) was added at 0° C. After 5 min the solution was evaporated and co-evaporated with toluene (2×5 mL) to dryness. The residue was purified on silica gel flash column chromatography using 5% acetone in dichloromethane to afford the title compound 1d as a white solid (17 mg, 21%). ¹H-NMR (CDCl₃) δ 3.72-3.86 (2H, m, 4′-H, 6′ax-H); 4.14-4.78 (11H, m, 1′-H, 5′-H, 6′eq-H, CH₂O(Fmoc), 9-H (Fmoc)); 4.98 (1H, br s, 2′-H); 5.50 (1H, s, PhCH); 5.66 (1 H, br s, 3′-H); 7.20-7.50 (13 H, m, H arom); 7.65 (4H, m, H arom); 7.78 (4H, d, J=7.7 Hz, H arom); 8.60 (1H, s, 8-H); 8.81 (1H, br s, 2-NH); 8.90 (1H, s, 2-H). HRMS calcd for C₆₃H₅₀N₅O₁₀ (MH)+ 814.2877, found 814.2883

### 1,5-Anhydro-2-deoxy-2-N⁶-bis(9-fluorenylmethoxycarbonyl)adenin-9-yl]-3-O-(9-fluorenylmethoxycarbonyl)-D-altro-hexitol 1f.

The compound 1c (2.9 g, 2.8 mmol) was dissolved in dichloromethane (30 mL) and TFA (4 mL) was added at 0° C. The reaction was monitored by TLC. After 1 h stirring at room temperature ethanol (20 mL) was added and the yellow-brown solution was evaporated and co-evaporated with toluene (2×30 mL) to dryness. The residue was purified by silica gel flash column chromatography using a stepwise gradient of methanol (24%) in dichloromethane to afford the title compound 1f as a white solid (1.7 g, 64%). ¹H-NMR (CDCl₃) δ 2.0-2.8 (2H, br s, 4′-OH and 5′-OH); 3.83-3.95 (4H, m, 4′-H, 5′-H, 6′-H); 4.10-4.61(11H, m, 1′-H, CH₂O(Fmoc), 9-H (Fmoc)); 5.00 (1H, br s, 2′-H); 5.72 (1H, br s, 3′-H); 7.19-7.50 (21H, m, H arom); 7.65 (6H, m, H arom); 7.80 (2H, d, J=7.7 Hz, H arom); 8.55 (1H, s, 8-H); 8.94 (1H, s, 2-H). HRMS calcd for C₅₆H₄₆N₅O₁₀(MH)+ 948.3245, found 948.3253.

### 1,5-Anhydro-2-deoxy-2-[N⁶-bis(9-fluorenylmethoxycarbonyl)adenin-9-yl]-3-O-(9-fluorenylmethoxycarbonyl)-6-O-monomethoxytrityl-D-altro-hexitol 1g.

Monomethoxytrityl chloride (0.65 g, 2.1 mmol) was added to a stirred solution of 1f (1.6 g, 1.7 mmol) in dry pyridine (15 mL) at room temperature under nitrogen. The reaction was monitored with TLC. After 2 h stirring, methanol (3 mL) was added and the solution was evaporated and co-evaporated with toluene (2×15 mL) to dryness. The residue was purified on silica gel flash column chromatography using 3% acetone in dichloromethane. Precipitation from dichloromethane-hexane at −60° C. affords the title compound 1g as a white powder (1.2 g, 63%). ¹H-NMR (CDCl₃) δ 1.94 (1H, br s, 4′-OH); 3.38 (dd, 1H, 6′ax-H, J=1.1 Hz, J=1.1 Hz ); 3.56 (dd, 1H, 6′ax-H, J=1.1 Hz, J=1.1 Hz); 3.79 (3H, s, CH₃); 3.89 (2H, brs, 4′-H, 5′-H; 4.06-4.18 (2H, m, 1-H); 4.25-4.69 (9H, m, CH₂O(Fmoc), 9-H (Fmoc)); 5.04 (1H, brs, 2′-H); 5.56 (1H, brs, 3′-H); 6.82 (2H, d, J=8.9 Hz, H arom); 7.19-7.50 (24H, m, H arom); 7.65 (6H, m, H arom); 7.80 (2H, d, J=7.7 Hz, H arom); 8.79 (1H, s, 8-H); 8.96 (1H, s, 2-H). HRMS calcd for C₇₆H₆₂N₅O₁₁ (MH)+ 1220.4446, found 1220.4454.

### Synthesis of 1,5-Anhydro-2-deoxy-3-O-(9-fluorenylmethoxycarbonyl)-2-(N²O⁶-bis(9-fluorenylmethoxycarbonyl)quanin-9-yl)-6-O-monomethoxytrityl-D-altro-hexitol 2g

### 1,5-Anhydro-4,6-O-benzylidene-2-deoxy-2-[N²,O⁶-bis(9-fluorenyl methoxycarbonyl)guanin-9-yl]-D-altrohexitol 2c.

1,5-Anhydro4,6-O-benzylidene-2-deoxy-(guanin-9-yl)-D-altro-hexitol 2b (M. Abramov et al. Nucleosides, Nucleotides and Nucleic Acids 2004, 23, 439-455) (1.95 g, 5.0 mmol) was co-evaporated with pyridine (2×50 mL) and to the resulting suspension in pyridine (30 mL) was added TMSCI (6.4 mL, 50 mmol) dropwise at 0° C. under argon. The resulting clear solution was stirred for 2 hours at room temperature. A Fmoc chloride (5.2 g, 20 mmol) was added in 1 g portions over 3 h and stirring was continued for 1 h. Methanol (10 mL) was added dropwise at 0° C. and reaction mixture was stirred for 10 min. The resulting mixture was evaporated and co-evaporated with toluene (2×30 mL) under reduced pressure. The residue was extracted with ethyl acetate, washed with water, dried over magnesium sulfate and purified by flash silica gel column chromatography, using methanol (1.5%) in dichloromethane. Yield of 1,5-anhydro-4,6-O-benzylidene-2-deoxy-2-[N²-(9-fluorenylmethoxycarbonyl)guanin-9-yl]-3-O-trimethylsilyl-D-altro-hexitol 3.0 g (66%). ¹H NMR (CDCl₃, δ): 0.21 (9H, s, CH₃Si); 3.54 (1H, dd, J=1.8 Hz, J=9.5 Hz, 4′-H); 3.72 (1H, t, J=10.5,Hz, 6′ax-H), 4.09-4.70 (9H, m, 1′-H, 2′-H, 3′-H, 5′-H, 6′eq-H, 9-H(Fmoc) and CH₂O(Fmoc); 5.44 (1H, s, PhCH); 7.20-7.45 (9H, m, H arom); 7.55-7.60 (4H, m, H arom (Fmoc)); 7.87 (1H, brs, 2-NH); 8.37 (1H, s, 8-H); 11.30 (1H, br s, NH). HRMS: calcd for C₃₆H₃₈N₅O₇Si (MH)⁺ 680.2541, found 680.2535. 1,5-Anhydro4,6-O-benzylidene-2-deoxy-2-[N²,O⁶-bis(9-fluorenylmethoxycarbonyl)guanin-9-yl]-3-O-trimethylsilyl-D-altro-hexitol (300 mg) was isolated as a minor product. ¹H NMR (CDCl₃, δ): 0.40 (9H, s, CH₃Si); 3.45 (1H, dd, J=1.8 Hz, J=9.5 Hz, 4′-H); 3.64 (1H, t, J=10.5, Hz, 6′ax-H), 4.09-4.70 (12H, m, 1′-H, 2′-H, 3′-H, 5′-H, 6′eq-H, 9-H(Fmoc) and CH₂O(Fmoc); 5.39 (1H, s, PhCH); 7.02-7.38 (18H, m, 2-NH and H arom); 7.50-7.60 (4H, m, H arom (Fmoc)); 8.37 (1H, s, 8-H). HRMS: calcd for C₅₁H48N₅O₉Si (MH)⁺ 902.3221, found 902.3228. A solution of 1,5-anhydro4,6-O-benzylidene-2-deoxy-2-[N²,O⁶-bis(9-fluorenylmethoxycarbonyl)guanin-9-yl]-3-O-trimethylsilyl-D-altro-hexitol (3.0 g, 3.3 mmol) was dissolved in THF (10 mL) and 1 N NBu₄F (6 mL) was added dropwise at 0° C. to the resulting solution. After 30 min the solution was added slowly dropwise into ice-cold water (250 mL) with stirring. The obtained solid was filtered off, dried and purified by flash silica gel column chromatography, using a methanol (2.5%) in dichloromethane. A mixture of two products (2.1 g) was isolated.

1,5-Anhydro-4,6-O-benzylidene-2-deoxy-2-[N²-(9-fluorenylmethoxycarbonyl)guanin-9-yl]-D-altro-hexitol 2c. ¹H NMR (DMSO-d6, δ) 3.64 (1H, dd, J=1.8 Hz, J=9.5 Hz, 4′-H); 3.79 (1H, t, J=10.5, Hz, 6′ax-H), 4.09-4.70 (9H, m, 1′-H, 2′-H, 3′-H, 5′-H, 6′eq-H, 9-H(Fmoc) and CH₂O(Fmoc); 5.58 (1H, s, PhCH); 5.73 (1H, br s, 3′-OH); 7.20-7.36 (5H, m, H arom); 7.33-7.41 (4H, m, H arom (Fmoc)); 7.73-7.80 (4H, m, H arom (Fmoc)); 8.08 (1H, s, 2-NH); 8.10 (1H, s, 8-H); 11.30-11.90 (1H, br d, NH). HMRS calcd for C₃₃H₃₀N₅O₇ (MH)+ 608.2145, found 608.2151.

1,5-Anhydro4,6-O-benzylidene-2-deoxy-2-[N²,O⁶-bis(9-fluorenylmethoxycarbonyl)-guanin-9-yl]-D-altro-hexitol. 2d. ¹H NMR (CDCl₃, δ) 2.42 (1H, br s, 3′-OH); 3.57 (1H, dd, J=1.8 Hz, J=9.5 Hz, 4′-H); 3.78 (1H, t, J=10.5,Hz, 6′ax-H); 3.95-4.62 (12H, m, 1′-H, 2′-H, 3′-H, 5′-H, 6′eq-H, 9-H(Fmoc) and CH₂O(Fmoc); 5.47 (1H, s, PhCH); 7.14-7.48 (18H, m, 2-NH and H arom); 7.58-7.65 (4H, m, H arom (Fmoc)); 8.32 (1H, s, 8-H). HMRS calcd for C₄₈H₄₀N₅O₉ (MH)+ 830.2826, found 830.2817.

### 1,5-Anhydro4,6-O-benzylidene-2-deoxy-2-[N²,O⁶-bis(9-fluorenyl methoxycarbonyl)guanin-9-yl]-3-O-(9-fluorenylmethoxycarbonyl)-D-altro-hexitol 2e.

The mixture (2,1 g) of 1,5-anhydro4,6-O-benzylidene-2-[N²-(9-fluorenylmethoxycarbonyl)guanin-9-yl]-2-deoxy-D-altro-hexitol 2c and 1,5-anhydro4,6-O-benzylidene-2-[N²,O⁶-bis(9-fluorenylmethoxycarbonyl)guanin-9-yl]-2-deoxy-D-altro-hexitol 2e in pyridine (120 mL) was evaporated up to 25 mL and FmocCl (4.0 g, 15.4 mmol) was added in 1 g portions for 3 h and stirring was continued for 1 h. Methanol (10 mL) was added dropwise at 0° C. and reaction mixture was stirred for 10 min. The resulting mixture was evaporated and co-evaporated with toluene (2×30 mL) under reduced pressure. The residue was extracted with ethyl acetate, washed with water, dried over magnesium sulfate and purified by flash silica gel column chromatography, using methanol (1.5%) in dichloromethane. Yield 2.2 g (42%) based on 1,5-anhydro4,6-O-benzylidene-2-deoxy-(guanin-9-yl)-D-altro-hexitol 2b. ¹H NMR (CDCl₃) δ 3.67 (1H, dd, J=1.8 Hz, J=9.5 Hz, 4′-H); 3.78 (1H, t, J=10.5, Hz, 6′ax-H), 3.85-4.50 (14H, m, 1′-H, 2′-H, 5′-H, 6′eq-H, 9-H(Fmoc) and CH₂O(Fmoc); 5.19 (1H, br s, 3′-OH); 5.30 (1H, s, PhCH); 7.00-7.60 (27H, m, H arom); 7.70-7.82 (2H, m, H arom (Fmoc)); 8.31 (1H, s, 8-H). HRMS: calcd for C₆₃H₅₀N₅O₁₁ (MH)+ 1052.3507, found 1052.3541.

### 1,5-Anhydro-2-deoxy-3-O-(9-fluorenylmethoxycarbonyl)-2-[N²-(9-fluorenylmethoxycarbonyl)guanin-9-yl]-6-D-altro-hexitol 2f.

To a solution of 1,5-anhydro4,6-O-benzylidene-2-[N²,O⁶-bis(9-fluorenylmethoxycarbonyl)guanin-9-yl]-3-O-(9-fluorenylmethoxycarbonyl)-2-deoxy-D-altro-hexitol 2e (2.2 g, 2.1 mmol) in dichloromethane (30 mL), TFA (5 mL) was added dropwise at 0° C. and the reaction mixture was stirred for 30 min. Water (100 μL, 5.6 mmol was added and stirring was continued for 15 min. Ethanol (80%, 10 mL) was added and solvents were removed. The residue was coevaporated with toluene (2×30 mL). The crude material was subjected to flash silica gel column chromatography, using 4% of methanol in dichloromethane, to afford the title compound as white foam (1.0 g, 52%). ¹H-NMR (CDCl₃) δ 2.0-2.8 (2H, br s, 4-OH and 5-OH); 3.80-4.48 (15H, m, 1′-H, 4′-H, 5′-H, 6′-H); CH₂O(Fmoc), 9-H (Fmoc)); 5.06 (1H, br s, 3′-H); 6.91-7.58 (23H, m, 2-NH and H arom (Fmoc)); 7.77-7.80 (2H, m, H arom (Fmoc)); 8.85 (1H, s, 8-H). HRMS calcd for C₅₆H₄₆N₅O₁₁ (MH)+ 964.3194, found 964.3174.

### 1,5-Anhydro-2-deoxy-3-O-(9-fluorenylmethoxycarbonyl)-2-(N 2 -bis(9-fluorenylmethoxycarbonyl)guanin-9-yl)-6-O-monomethoxytrityl-D-altro-hexitol 2g.

A solution of 1,5-anhydro-3-O-(9-fluorenylmethoxycarbonyl)-2-[N²-(9-fluorenylmethoxycarbonyl)guanin-9-yl]-2-deoxy-6-D-altro-hexitol (1.0 g, 1 mmol) in pyridine (50 mL) was evaporated up to 10 mL and MMTrCl (620 mg, 2 mmol) was added under argon at room temperature. After 3 h methanol (5 mL) was added. The volatiles were removed. The residue was co-evaporated with toluene (2×20 mL). The residue was purified by silica gel flash column chromatography using 2% methanol in dichloromethane. Precipitation from dichloromethane-hexane at −60° C. affords the title compound 2g as a white powder (1.0 g, 82%). ¹H-NMR (CDCl₃) δ 2.04 (1H, br s, 4′-OH); 3.42 (dd, 1H, 6′ax-H, J=1.1 Hz ); 3.54 (dd, 1H, 6′eq-H, J=1.1 Hz, J=1.1 Hz ); 3.79 (3H, s, CH₃); 3.89-4.62 (13H, m, 2′-H, 4′-H, 5′-H, CH₂O(Fmoc), 9-H (Fmoc)); 4.96 (1H, br s, 3′-H); 6.82 (2H, d, J=8.9 Hz, H arom); 7.06-7.60 (35H, m, H arom and 2-NH); 7.74 (2H, m, H arom (Fmoc)); 8.49 (1H, s, 8-H). HRMS calcd for C₇₆H₆₂N₅O₁₂ (MH)⁺ 1236.4395, found 1236.4346

### 1,5-Anhydro-2-deoxy-3-O-(9-fluorenylmethoxycarbonyl)-2-(N²-dimethylamino methylene)guanin-9-yl)-6-O-monomethoxytrityl-D-altro-hexitol 3e

### 1,5-Anhydro-4,6-O-benzylidene-2-deoxy-[2-(N2-dimethylamino methylene)guanin-9-yl]-3-O-(9-fluorenylmethoxycarbonyl)-D-altro-hexitol 3c.

A mixture of 1,5-anhydro4,6-O-benzylidene-2-deoxy-2-(N²-dimethylaminomethylene)guanin-9-yl]-2-deoxy-D-altro-hexitol 3b (2.5 g, 5.7 mmol) and pyridine (20 mL) was evaporated up to 5 mL and Fmoc chloride (1.75 g, 6.5 mmol) was added in 500 mg portions for 30 min and stirring was continued for 1 h. Methanol (5 mL) was added dropwise at 0° C. and the reaction mixture was stirred for 10 min. The resulting mixture was evaporated and co-evaporated with toluene (2×30 mL) under reduced pressure. The residue was extracted with ethyl acetate, washed with water, and purified by flash silica gel column chromatography, using a methanol (1.5%) in dichloromethane. Yield 3.0 g (80%). ¹H NMR: (CDCl₃, δ): 3.09 (6H, s, NMe₂); 3.67-3.85 (2H, m, 4′-H, 6′ax-H), 4.10-4.60 (7H, m, 1′-H, 2′-H, 5′-H, 6′eq-H, 9-H(Fmoc) and CH₂O(Fmoc); 5.51 (1H, s, PhCH); 5.86 (1H, br t, 3′-H); 7.29-7.44 (9H, m, H arom); 7.50-7.68 (2H, m, H arom(Fmoc)); 7.77-7.82 (2H, m, H arom (Fmoc)); 8.03 (1H, s, 8-H); 8.87 (1H, s, CH); 8.95 (1H, br s, NH). HRMS: calcd for C₃₆H₃₄N₆O₈ (M)⁺ 662.2489, found 662.2451.

### 1,5-Anhydro-2-deoxy-3-(9-fluorenylmethoxycarbonyl)-2-(N2-dimethyl aminomethylene)-guanin-9-yl]-6-D-altro-hexitol 3d.

To a solution of hexitol 3c (2.2 g, 3.3 mmol) in dichloromethane (20 mL), TFA (2 mL) was added dropwise at 0° C. and reaction mixture was stirred for 30 min. Water (100 μL, 5.6 mmol) was added and stirring was continued for 15 min. The light yellow solution was neutralized with pyridine, washed with saturated NaCl, evaporated to dryness and the crude material was precipitated from dichloromethane-hexane at 0° C. to afford the title compound 3d as white solid in 95% yield. ¹H-NMR (DMSO-d₆) δ 3.02 (6H, s, NMe); 3.06 (6H, s, NMe);3.60-3.80 (4H, m, 4′-H, 6′ax-H, 2xOH), 4.00-4.60 (7H, m, 1′-H, 2′-H, 5′-H, 6′eq-H, 9-H(Fmoc) and CH₂O(Fmoc); 5.43 (1H, br t, 3′-H); 7.29-7.39 (4H, m, H arom);7.55-7.58 (2H, m, H arom(Fmoc)); 7.74-7.78 (2H, m, H arom (Fmoc)); 8.08 (1H, s, 8-H); 8.76 (1H, s, CH); 11.10 (1H, brs, NH).

### 1,5-Anhydro-2-deoxy-(9-fluorenylmethoxycarbonyl)-2-(N²-dimethyl aminomethylene)-guanin-9-yl)-6-O-monomethoxytrityl-D-altro-hexitol (3e).

A solution of 1,5-anhydro-3-(9-fluorenylmethoxycarbonyl)-2-(3-dimethylaminomethylene)guanin-9-yl]-2-deoxy-6-D-altro-hexitol 3d (1.15 g, 2 mmol) in pyridine (10 mL) was evaporated up to 3 mL and MMTrCl (620 mG, 2 mmol) was added under argon at room temperature. After 3 h, methanol (1.5 mL) was added and the solution was washed with water (3×50 mL), dried over magnesium sulfate and evaporated to dryness. Precipitation from dichloromethane-hexane at 0° C. to afford the title compound 3e as a white powder (1.35 g, 80%). ¹H-NMR (CDCl₃) δ 3.05 (6H, s, NMe₂); 3.47 (2H, m, 4′-H, 6′ax-H); 3.80 (3H, s, CH₃); 3.90 m 2H and 4.10-4.60 5H m (1′-H, 2′-H, 5′-H, 6′eq-H, 9-H(Fmoc) and CH₂O(Fmoc); 5.67 (1H, br t, 3′-H); 6.84-6.88 (2H, m, H arom); 7.29-7.62 (16H, m, H arom); 7.59-7.66 (2H, m, H arom(Fmoc)); 7.77-7.81 (2H, m, H arom (Fmoc)); 8.07 (1H, s, 8-H); 8.77 (1H, s, CH); 9.21 (1H, br s, NH). HRMS calcd for C₄₉H₄₇N₆O₈ (MH)⁺ 847.3455, found 847.3458

### 1,5-Anhydro-2-deoxy-3-O-(9-fluorenylmethoxycarbonyl)-6-O-monomethoxytrityl-2-(thymin-1-yl)-D-altro-hexitol 4e

### 1,5-Anhydro-4,6-O-benzylidene-2-deoxy-3-O-(9-fluorenylmethoxy carbonyl)-(thymin-1 -yl)-D-altro-hexitol 4c.

9-Fluorenylmethoxycarbonyl chloride (1.03 g, 4 mmol) was added in four portions to a solution of 4b (M. Abramov et al. Nucleosides, Nucleotides and Nucleic Acids 2004, 23, 439-455) (1.08 g, 3 mmol) in dry pyridine (10 mL) under nitrogen and the reaction mixture was stirred at room temperature for 2 h. The reaction was monitored by TLC. Then, MeOH (5 mL) was added and the stirring was continued for 10 min. The yellow solution was evaporated and co-evaporated with toluene (2×10 mL) to dryness. The residue was subjected to silica gel flash column chromatography using 1.5% of methanol in dichloromethane as eluent. Precipitation from dichloromethane-hexane at −60° C. affords the title compound 4c as a white powder (1.1 g, 63%). ¹H-NMR (CDCl₃) δ 2.02 (3H, s, 5-Me); 3.76-3.88 (2H, m, 4′-H and 9-H(Fmoc)); 4.10-4.60 (7H, m, 6′ax-H, 1′ax-H, 5′-H, 6′eq-H, 1′eq-H, CH₂O(Fmoc)); 4.65 (1H, t, J=2.9 Hz, 2′-H); 5.50 (1H, br s, 3′-H); 5.64 (1H, s, PhCH); 7.23-7.35 (5H, m, H arom); 7.35-7.46 (4H, m, H arom); 7.62 (2H, d, J=7.0 Hz, H arom (Fmoc)); 7.88 (2H, d, 6-H, J=7.7 Hz, H arom (Fmoc)); 7.88 (1H, d, 6-H, , J=1.1 Hz); 8.72 (1H, br. s, NH). HMRS calcd for C₃₃₄H₃₁N₂O₈ (MH)+ 583.2081, found 583.2078.

### 1,5-Anhydro-2-deoxy-3-O-(9-fluorenylmethoxycarbonyl)-2-(thymin-1-yl)-D-altro-hexitol4d.

The compound 4c (1.75 g, 3 mmol) was dissolved in dichloromethane (30 mL) and TFA (3 mL) was added at 0° C. The reaction was monitored by TLC. After 1 h stirring at room temperature, ethanol (20 mL) was added and the yellow-brown solution was evaporated and co-evaporated with toluene (2×30 mL) to dryness. The residue was purified on silica gel flash column chromatography using 5% methanol in dichloromethane to afford the title compound 4d as a white solid (1.1 g, 74%). ¹H-NMR (CDCl₃) δ 1.80 (3H, s, CH₃); 3.20 (2H, br s, 6′-OH and 4′-OH); 3.70-3.95 (3H, m 4′-H, 5′-H, 6′ax-H); 3.96-4.50 (7H, m, 6′eq-H, 1′ax-H, 3′-H, 1′eq-H, 9-H(Fmoc), CH₂O(Fmoc)); 5.50 (1H, br s, 3′-H); 7.20-7.40 (4H, m, H arom); 7.58 (2H, d, J=7.0 Hz, H arom (Fmoc)); 7.74 (1H, d, 6-H, J=7.7 Hz, H arom (Fmoc)); 7.80 (1H, d, 6-H, J=1.1 Hz); 9.50 (1H, br. s, NH). HMRS calcd for C₂₆H₂₇N₂O₈ (MH)+ 495.1768, found 495.1765.

### 1,5-Anhydro-2-deoxy-3-O-(9-fluorenylmethoxycarbonyl)-6-O-monomethoxytrityl-2-(thymin-1-yl)-D-altro-hexitol 4e.

MMTrCl (0.95 g, 3 mmol) was added to a stirred solution of 4d (1.0 g, 2 mmol) in dry pyridine (15 mL) at room temperature under nitrogen. The reaction was monitored by TLC. After 2 h stirring, methanol (3 mL) was added and the solution was evaporated and co-evaporated with toluene (2×15 mL) to dryness. The residue was purified on silica gel flash column chromatography using 3% methanol in dichloromethane. Precipitation from dichloromethane-hexane at −60° C. affords the title compound 4e as a white powder (1.2 g, 52%). ¹H-NMR (CDCl₃) δ 1.80 (3H, s, CH₃); 3.40 (dd, 1H, 6′ax-H, J=1.1 Hz, J=1.1 Hz ); 3.48 (dd, 1H, 6′ax-H, J=1.1 Hz, J=1.1 Hz); 3.78 (3H, s, CH₃); 3.72-3.85(m, 1H, 4′-H); 4.05-4.30(4H, m, 1′ax-H, 3′-H, 1′eq-H, 5′-H, 9-H(Fmoc)); 4.40-4.50 (2H, m, CH₂O(Fmoc)); 4.66 (1H, br s, 2′-H); 5.50 (1H, br s, 3′-H); 6.82 (2H, d, J=8.9 Hz, H arom); 7.22-7.40 (16H, m, H arom); 7.58 (2H, d, J=7.0 Hz, H arom (Fmoc)); 7.75 (1H, d, 6-H, J=7.7 Hz, H arom (Fmoc)); 7.80 (1H, d, 6-H, J=1.1 Hz); 9.50 (1H, br. s, NH). HRMS calcd for C₄₆H₄₃N₂O₉ (MNa)+ 767.2969, found 767.2977.

### 1,5-Anhydro-2-deoxy-3-O-(9-fluorenylmethoxycarbonyl)-2-uracyl-1 -yl]-6-O-monomethoxytrityl-D-altro-hexitol 5e

### 1,5-Anhydro4,6-O-benzylidene-2-deoxy-3-O-(9-fluorenylmethoxy carbonyl)-(uracil-1-yl)-D-altro-hexitol 5c.

9-Fluorenylmethoxycarbonyl chloride (1.03 g, 4 mmol) was added in four portions to a solution of 5b (1.04 g, 3 mmol) in dry pyridine (10 mL) under nitrogen and the reaction mixture was stirred at room temperature for 2 h. The reaction was monitored by TLC. Then, MeOH (5 mL) was added and the stirring was continued for 10 min. The yellow solution was evaporated and co-evaporated with toluene (2×10 mL) to dryness. The residue was subjected to silica gel flash column chromatography using 1.5% of methanol in dichloromethane as eluent. Precipitation from dichloromethane-hexane at −60 C. affords the title compound 5c as a white powder (1.1 g, 63%). ¹H-NMR (CDCl₃) δ 3.76-3.88 (2H, m, 4′-H and 9-H(Fmoc)); 4.10-4.60 (7H, m, 6′ax-H, 1′ax-H, 5′-H, 6′eq-H, 1′eq-H, CH₂O(Fmoc)); 4.65 (1H, t, J=2.9 Hz, 2′-H); 5.51 (1H, br s, 3′-H); 5.62 (1H, s, PhCH); 5.82 (1H, dd, 5-H, J=1.8 Hz J=8.4 Hz); 7.23-7.35 (5H, m, H arom); 7.36-7.46 (4H, m, H arom); 7.62 (2H, d, J=7.3 Hz, H arom (Fmoc)); 7.80 (2H, d, J=7.7 Hz, H arom (Fmoc)); 8.05 (1H, d, 6-H, J=8.4 Hz); 9.46 (1H, br. s, NH). HMRS calcd for C₃₂H₂₉N₂O₈ (MH)+ 569.1925, found 569.1924.

### 1,5-Anhydro-2-deoxy-3-O-(9-fluorenylmethoxycarbonyl)-2-(uracil-1-yl)-D-altro-hexitol 5d.

The compound 5c (1.70 g, 3 mmol) was dissolved in dichloromethane (30 mL) and TFA (3 mL) was added dropwise at 0° C. and reaction mixture was stirred for 30 min. Water (100 μL, 5.6 mmol) was added and stirring was continued for 15 min. The light yellow solution was neutralized with pyridine, washed with saturated NaCl, evaporated to dryness and crude material was precipitated from dichloromethane-hexane at 0° C. affords the title compound 5d as white solid in 95% yield. ¹H-NMR (CDCl₃) δ 3.20 (2H, br s, 6′-OH and 4′-OH); 3.70-3.95 (3H, m 4′-H, 5′-H, 6′ax-H); 3.96-4.50 (7H, m, 6′eq-H, 1′ax-H, 3′-H, 1′eq-H, 9-H(Fmoc), CH₂O(Fmoc)); 5.30 (1H, br s, 3′-H); 5.64 (1H, d, 5-H, J=8.1 Hz); 7.20-7.40 (4H, m, H arom); 7.60 (2H, d, J=7.0 Hz, H arom (Fmoc)); 7.71 (1H, d, 6-H, J=7.7 Hz, H arom (Fmoc)); 8.00 (1H, d, 6-H, , J=8.1Hz); 10.0 (1H, br. s, NH). HMRS calcd for C₂₅H₂₅N₂O₈ (MH)+ 481.1611, found 481.1611.

### 1,5-Anhydro-2-deoxy-3-O-(9-fluorenylmethoxycarbonyl)-6-O-mono-methoxytrityl-2-(uracil-1-yl)-D-altro-hexitol 5e.

Monomethoxytrityl chloride (0.95 g, 3 mmol) was added to a stirred solution of 5d (1.0 g, 2.1 mmol) in dry pyridine (15 mL) at room temperature under nitrogen. The reaction was monitored by TLC. After 2 h stirring, methanol (3 mL) was added and the solution was evaporated and co-evaporated with toluene (2×15 mL) to dryness. Precipitation from dichloromethane-hexane at −60° C. affords the title compound 5e as a white powder (1.1 g, 72%). ¹H-NMR (CDCl₃, 500 MHz) δ 3.40 (dd, 1H, 6′ax-H, J=1.1Hz, J=1.1Hz ); 3.48 (dd, 1H, 6′ax-H, J=1.1 753.2812 Hz, J=1.1 Hz ); 3.78 (3H, s, CH₃); 3.72-3.85(m, 1H, 4′-H); 4.05-4.30(4H, m, 1′ax-H, 3′-H, 1′eq-H, 5′-H, 9-H(Fmoc)); 4.40-4.50 (2H, m, CH₂O(Fmoc)); 4.66 (1H, br s, 2′-H); 5.50 (1H, br s, 3′-H); 5.88 (1H, d, 5-H, J=8.1 Hz); 6.82 (2H, d, J=8.9 Hz, H arom); 7.22-7.40 (16H, m, H arom); 7.58 (2H, d, J=7.0 Hz, H arom (Fmoc)); 7.75 (1H, d, 6-H, J=7.7 Hz, H arom (Fmoc)); 7.80 (1H, d, 6-H, J=8.1 Hz); 8.95 (1H, br. s, NH). HMRS calcd for C₄₅H₄₁N₂O₉ (MH)+ 753.2812, found 753.2812.

### 1,5-Anhydro-2-deoxy-3-O-(9-fluorenylmethoxycarbonyl)-2-[N⁴(9-fluorenylmethoxycarbonyl)-cytosin-1-yl]-6-O-monomethoxytrityl-D-altro-hexitol 6e

### 1,5-Anhydro4,6-O-benzylidene-2-deoxy-2-(cytosin-1-yl)-D-altro-hexitol 6b.

Chlorotrimethylsilane (6.4 mL, 50 mmol) was added to a stirred suspension of 1,5-anhydro-4,6-O-benzylidene-2-deoxy-2-(uracil-1-yl)-D-altro-hexitol 5b (3.6 g, 10.0 mmol) in dry pyridine (40 mL) under nitrogen. After 1 h, the reaction mixture was cooled in an ice-bath and 1.2.4-1H-triazole (6.9 g, 100 mmol) and phosphorous oxychloride (1.86 mL, 20 mmol) were added and stirring was continued for 5 hours. The volatiles were removed and the residue was co-evaporated with toluene (3×20 mL) and partitioned between water and ethyl acetate. The organic layer was washed with water, brine, and evaporated to dryness to afford yellow foam. This crude intermediate was dissolved in dioxane (40 mL), and 25% aqueous ammonia (15 mL) was added. After 45 min stirring, the volatiles were evaporated and the solid was co-evaporated with toluene. The residue was suspended in chloroform, co-evaporated with silica gel and subjected to silica gel column chromatography, using a stepwise gradient of methanol (2-10%) in dichloromethane, to afford the title compound 6b as a white powder (1.9 g, 55%). ¹H NMR (DMSO-d6) δ 3.60 (dd, 1H, J=2.3 and 9.6 Hz, 4′-H); 3.64 (t, 1H, J=10.2 Hz; 6′-Ha); 3.91 (dd, 1H, J=4.9 and 9.6 Hz, 5′-H); 4.00 (m, 1H, 3′-H); 4.00-4.26 (m, 3H, 1′-Ha, 1′-He, 6′-He); 4.29 (m, 1H, 2′-H); 5.65 (s, 1H, Ph—CH); 5.72 (d, 1H, J=4.2 Hz, 3′-OH); 5.77 (d, 1H, J=7.5 Hz, 5-H); 7.05 and 7.19 (2 br s, 2H, 4-NH₂); 7.30-7.45 (m, 5H, ar-H); 7.94 (d, 1H, J=7.5 Hz, 6-H). ¹³C NMR (DMSO-d6) δ 57.46 (C-2′); 64.00 (C-1′); 64.87 (C-3′); 65.79 (C-5′); 68.28 (C-4′); 94.09 (C-5); 101.20 (Ph—CH); 126.50 (2C, ar-Cₒ); 128.10 (2C, ar-Cₘ); 128.95 (ar-Cₚ); 137.93 (ar-Cᵢ); 143.75 (C-6); 154.98 (C-2); 165.19 (C4). HRMS (thgly) calcd. for C₁₇H₂₀N₃O₅ (MH)⁺ 346.1403, found 346.1380.

### 1,5-Anhydro-4,6-O-benzylidene-2-deoxy-2-[N⁴-(9-fluorenylmethoxycarbonyl)-cytosin-1-yl]-3-O-(9-fluorenylmethoxycarbonyl)-D-altro-hexitol 6c.

9-Fluorenylmethoxycarbonyl chloride (5.0 g, 19 mmol) was added in 1 g portions to a stirred solution of 6b (1.5 g, 4.4 mmol) in dry pyridine (20 mL) for 1 h under nitrogen. The reaction mixture was stirred at room temperature for 1 h and pyridine was removed. The residue was coevaporated with toluene, suspended in dichloromethane (50 ml) and the organic phase was washed with water. The solvent was removed and the crude material was subjected to flash silica gel column chromatography using a mixture of dichloromethane/ethyl acetate (1/5) as eluent, to afford the title compound 6c (1.75 g, 51%). ¹H-NMR (CDCl₃) δ 3.60-3.82 (2H, m, 4′-H and 9-H(Fmoc)); 4.05-4.60 (10H, m, 6′ax-H, 1′ax-H, 5′-H, 6′eq-H, 1′eq-H, CH₂O(Fmoc)); 4.82 (1H, br s, 2′-H); 5.45 (1H, s, PhCH); 5.59 (1H, br s, 3′-H); 7.15-7.48 (14H, m, 6-H and H arom); 7.50-7.64 (4H, m, H arom (Fmoc)); 7.66-7.82 (4H, m, H arom (Fmoc)); 7.68 (2H, d, J=7.7 Hz, H arom (Fmoc)); 7.78 (4H, m, H arom (Fmoc)); 7.94 (1H, d, 6-H, J=7.8 Hz); 8.95 (1H, br. s, NH).

### 1,5-Anhydro-2-deoxy-2-[N⁴-(9-fluorenylmethoxycarbonyl)-cytosin-1 -yl]-3-O-(9-fluorenylmethoxycarbonyl)-D-altro-hexitol 6d.

Compound 6c (1.2 g, 1.5 mmol) was dissolved in dichloromethane (15 mL) and cooled to 0° C. TFA (2 mL) was then added, and the reaction mixture was stirred at room temperature for 45 min. Ethanol (80%) was added and solvents were removed and the residue was coevaporated with toluene. The crude material was subjected to flash silica gel column chromatography, using 2.5% of methanol in dichloromethane, to afford the title compound 44 as a white foam (0.75 g, 71%). ¹H-NMR (CDCl₃) δ; 3.05 (2H, br s, 6′-OH and 4′-OH); 3.70-3.95 (3H, m 4′-H, 5′-H, 6′ax-H); 3.96-4.45 (9H, m, 6′eq-H, 1′ax-H, 3′-H, 1′eq-H, 9-H(Fmoc), CH₂O(Fmoc)); 4.63 (1H, m, 3′-H); 5.49 (1H, br s, 3′-H); 6.81 (1H, d, J=7.7 Hz); 7.26-7.48 (8H, m, H arom); 7.55 (4H, m, H arom (Fmoc)); 7.65 (4H, m, H arom (Fmoc)); 8.04 (1H, d, J=7.7 Hz). HMRS calcd for C₄₀H₃₆N₃O₉ (MH)+ 702.2450, found 702.2480.

### 1,5-Anhydro-2-deoxy-2-[N⁴-(9-fluorenylmethoxycarbonyl)-cytosin-1-yl]-3-O-(9-fluorenylmethoxycarbonyl)-6-O-monomethoxytrityl-D-altro-hexitol 6e.

Monomethoxytrityl chloride (0.46 g, 1.42 mmol) was added to a solution of 6d (0.65 g, 0.9 mmol) in dry pyridine (6 mL) at room temperature under nitrogen. After 4 h, methanol (1 mL) was added and the volatiles were removed and the residue was co-evaporated with toluene. The residue was subjected to flash silica gel column chromatography using acetone (2%) in dichloromethane, to afford the title compound 6e as a white solid (0.55 g, 60%). ¹H-NMR (CDCl₃) δ 3.38 (dd, 1H, 6′ax-H, J=1.1 Hz, J=10.5 Hz); 3.48 (dd, 1H, 6′ax-H, J=1.1 Hz, J=10.5 Hz ); 3.78 (3H, s, CH₃); 3.72-3.85(m, 1H, 4′-H); 4.05-4.30 (4H, m, 1′ax-H, 1′eq-H, 5′-H, 9-H(Fmoc)); 4.40-4.50 (4H, m, CH₂O(Fmoc)); 4.66 (1H, br s, 2′-H); 5.50 (1H, br s, 3′-H); 5.78 (1H, dd, 6-H, J=1.8 Hz, J=8.1 Hz); 6.82 (2H, d, J=8.9 Hz, H arom); 7.22-7.40 (20H, m, H arom); 7.58 (2H, m, H arom (Fmoc)); 7.68 (2H, m, H arom (Fmoc)); 7.75 (4H, m, H arom (Fmoc)); 8.25 (1H, d, 6-H, J=8.1 Hz); 8.93 (1H, br s, NH). HMRS calcd for C₆₀H₅₂N₃O₁₀ (MH)+ 974.3653, found 974.3633.

### 1,5-Anhydro-2-deoxy-2-[N⁴-(9-fluorenylmethoxycarbonyl)-5-methylcytosin-1 -yl]-3-O-(9-fluorenylmethoxycarbonyl)-6-O-monomethoxytrityl-D-altro-hexitol 7e

### 1,5-Anhydro4,6-O-benzylidene-2-deoxy-2-(5-methylcytosin-1-yl)-D-altro-hexitol 7b.

60.1554Chlorotrimethylsilane (6.4 mL, 50 mmol) was added to a stirred suspension of 1,5-anhydro4,6-O-benzylidene-2-deoxy-2-(thymin-1-y)-D-altro-hexitol^{[3]} (3.6 g, 10.0 mmol) in dry pyridine (40 mL) under nitrogen. After 1 h, the reaction mixture was cooled in an ice-bath and 1.2.4-1H-triazole (6.9 G, 100 mmol) and phosphorous oxychloride (1.86 mL, 20 mmol) were added and stirring was continued for 5 hours. The volatiles were removed and the residue was coevaporated with toluene (3×25 mL) and partitioned between water and ethyl acetate. The organic layer was washed with water, brine, and evaporated to dryness to afford a yellow foam. This crude intermediate was dissolved in dioxane (40 mL), and 25% aqueous ammonia (15 mL) was added. After 45 min stirring, the volatiles were evaporated and the solid was co-evaporated with toluene. The residue was suspended in chloroform, adsorbed an silica gel and subjected to silica gel column chromatography, using a stepwise gradient of methanol (2-10%) in dichloromethane, to afford the title compound 7b as a white powder (2.0 g, 55%).

¹H-NMR (DMSO-d6) δ 0.08 1.97 (3H, s, CH₃); 3.53 (1H, dd, J=2.4 Hz, J=9.5 Hz, 4′-H); 3.69 (1H, t, J=10.4 Hz, 6′ax-H); 3.85-4.15 (7H, m, 1′ax-H, 5′-H, 6′eq-H, 3′-H, 1′ax-H, 2′-H and 3′-OH); 5.61 (1H, s, PhCH); 6.90 (2H, br s, NH₂,); 7.29-7.32 (3H, m, H arom); 7.39-7.45 (2H, m, H arom); 7.75 (1H, s, 6-H). HMRS calcd for C₁₈H₂₃N₃O₅ (MH)⁺ 360.1559, found 360.1554.

### 1,5-Anhydro-4,6-O-benzylidene-2-deoxy-2-[N⁴-(9-fluorenylmethoxy carbonyl)-5-methylcytosin-1-yl]-3-O-(9-fluorenylmethoxycarbonyl)-D-altro-hexitol 7c.

9-Fluorenylmethoxycarbonyl chloride (5.0 g, 19 mmol) was added in 1 g portions to a stirred solution of 7b (1.5 g, 4.2 mmol) in dry pyridine (20 mL) for 1 h under nitrogen. The reaction mixture was stirred at room temperature for 1 h and the pyridine was removed. The residue was co-evaporated with toluene, suspended in dichloromethane (50 ml) and the organic phase was washed with water. The solvent was removed and the crude material was subjected to flash silica gel column chromatography using a mixture of dichloromethane/ethyl acetate (1/5) as eluent, to afford the title compound 7c (1.45 g, 43%). ¹H-NMR (CDCl₃) δ 2.13 (3H, s, 5-Me); 3.77-3.83 (2H, m, 4′-H and 9-H(Fmoc)); 4.20-4.55 (10H, m, 6′ax-H, 1′ax-H, 5′-H, 6′eq-H, 1′eq-H, CH₂O(Fmoc)); 4.65 (1H, br s, 2′-H); 5.49 (1H, br s, 3′-H); 5.61 (1H, s, PhCH); 7.23-7.35 (5H, m, H arom); 7.35-7.46 (8H, m, H arom); 7.58 (2H, d, J=7.0 Hz, H arom (Fmoc)); 7.68 (2H, d, J=7.7 Hz, H arom (Fmoc)); 7.78 (4H, m, H arom (Fmoc)); 7.94 (1H, d, 6-H, J=1.1 Hz); 12.42 (1H, br. s, NH). HMRS calcd for C₄₈H₄₂N₃O₉ (MH)⁺ 804.2921, found 804.2911.

### 1,5-Anhydro-2-deoxy-2-[N⁴-(9-fluorenylmethoxycarbonyl)-5-methylcytosin-1-yl]-3-O-(9-fluorenylmethoxycarbonyl)-D-altro-hexitol 7d.

Compound 7c (1.2 g, 1.5 mmol) was dissolved in dichloromethane (15 mL) and cooled to 0° C. TFA (2 mL) was then added, and the reaction mixture was stirred at room temperature for 45 min. Ethanol (80%) was added and solvents were removed and the residue was co-evaporated with toluene. The crude material was subjected to flash silica gel column chromatography, using 2.5% of methanol in dichloromethane, to afford the title compound 7d as white foam (0.70 g, 65%). ¹H-NMR (CDCl₃) δ 2.05 (3H, s, CH₃); 3.70-3.95 (3H, m 4′-H, 5′-H, 6′ax-H); 3.96-4.50 (9H, m, 6′eq-H, 1′ax-H, 3′-H, 1′eq-H, 9-H(Fmoc), CH₂O(Fmoc)); 4.63 (1H, br s, 3′-H); 5.35 (1H, br s, 3′-H); 6.20 (2H, br s, 6′-OH and 4′-OH); 7.20-7.40 (8H, m, H arom); 7.58 (4H, m, H arom (Fmoc)); 7.74 (4H, m, H arom (Fmoc)); 8.40 (1H, d, 6-H, J=1.1 Hz); 9.50 (1H, br. s, NH). HMRS calcd for C₄₁H₃₈N₃O₉ (MH)+ 716.2608, found 716.2605.

### 1,5-Anhydro-2-deoxy-2-[N⁴-(9-fluorenylmethoxycarbonyl)-5-methyl cytosin-1-yl]-3-O-(9-fluorenylmethoxycarbonyl)-6-O-monomethoxytrityl-D-altro-hexitol 7e.

Monomethoxytrityl chloride (0.46 g, 1.42 mmol) was added to a solution of 7d (0.65 g, 0.9 mmol) in dry pyridine (6 mL) at room temperature under nitrogen. After 4 h, methanol (1 mL) was added and the volatiles were removed and the residue was co-evaporated with toluene. The residue was subjected to flash silica gel column chromatography using acetone (2%) in dichloromethane, to afford the title compound 7e as a white solid (0.55 g, 60%). ¹H-NMR (CDCl₃) δ 1.96 (3H, s, CH₃); 3.38 (dd, 1H, 6′ax-H, J=1.1 Hz, J=10.5 Hz ); 3.48 (dd, 1H, 6′ax-H, J=1.1 Hz, J=10.5 Hz ); 3.78 (3H, s, CH₃); 3.72-3.85(m, 1H, 4′-H); 4.05-4.30(4H, m, 1′ax-H, 1′eq-H, 5′-H, 9-H(Fmoc)); 4.40-4.50 (4H, m, CH₂O(Fmoc)); 4.66 (1H, br s, 2′-H); 5.50 (1H, br s, 3′-H); 6.82 (2H, d, J=8.9 Hz, H arom); 7.22-7.40 (20H, m, H arom); 7.58 (2H, m, H arom (Fmoc)); 7.68 (2H, m, H arom (Fmoc)); 7.75 (4H, m, H arom (Fmoc)); 8.09 (1H, d, 6-H, J=1.1 Hz). HMRS calcd for C₆₁H₅₄N₃O₁₀ (MH)+ 974.3653, found 988.3796.

1-30. (canceled)

31. An oligonucleotide array comprising oligonucleotides coupled to a surface, characterized in that at least one of said oligonucleotides is selected from an altritol oligonucleotide (ANA) or a hexitol oligonucleotide (HNA).

32. The oligonucleotide array according to claim 31, characterized in that all oligonucleotides of the oligonucleotide array are selected from altritol oligonucleotides (ANA).

33. A method for manufacturing an oligonucleotide array comprising the step of:
reacting a dienophile modified surface with a mixture of diene-alkene or -alkyne-modified tetrahydropyran comprising oligonucleotide and a free diene-alkene or -alkyne, in a ratio ranging from 5:95 to 95:5 of free diene-alkene or alkyne:diene-alkene or alkyne-modified tetrahydropyran comprising oligonucleotide.

34. A method for the detection of target nucleic acids in samples taken from the human or animal body comprising comprising the steps of:
(i) providing a sample suspected to contain the target nucleic acid;
(ii) providing an oligonucleotide array according to claims 31 or 32 wherein at least one oligonucleotide of the oligonucleotide array is essentially complementary to a part or all of the target nucleic acid;
(iii) optionally amplifying the target nucleic acid or preparing the sample for allowing detection such as with extractions or purifications;
(iv) contacting the oligonucleotide array with the sample under conditions allowing binding of the target nucleic acid to the oligonucleotides of the array;
(v) detecting the degree of binding or hybridization of the oligonucleotides of the array to the target nucleic acid in the sample as a measure of the presence, absence or amount of the target nucleic acid in the sample, or as a measure for the presence of a mutation or small nucleotide polymorphism (SNP) in the target nucleic acid in the sample.

35. The method according to claim 34, wherein the method further comprises the step of performing the hybridization and a further washing step in step (iv) at a temperature between 30° C. and 50° C.

36. The method according to claim 34, wherein said target molecules are RNA nucleic acids.

37. The method according to claim 34 wherein said method is for the detection of micro-organisms or the analysis of mutations in nucleic acids of micro-organisms.

38. The use according to claim 37, wherein said micro-organism is a virus.

39. The use according to claim 38, wherein said virus is HIV.

40. The method according to claim 34, wherein the target nucleic acid is the nucleic acid encoding for HIV protease or HIV reverse transcriptase.


SEQUENCE LISTING (51 sequences)

SEQ ID NO: 1 - DNA, 12 bp, Artificial sequence
  HIV Protease gene 5′ diene modified
gagacaacgggt

SEQ ID NO: 2 - DNA, 18 bp, Artificial sequence
  HIV Protease gene codon 10 sequence fragment
cagcgacccctcgtctca

SEQ ID NO: 3 - DNA, 18 bp, Artificial sequence
  HIV Protease gene codon 36 sequence fragment
ttagaagacatgaatttg

SEQ ID NO: 4 - DNA, 18 bp, Artificial sequence
  HIV Protease gene codon 54 sequence fragment
ggaggttttatcaaagta

SEQ ID NO: 5 - DNA, 18 bp, Artificial sequence
  HIV reverse transcriptase gene codon 74 sequence fragment
tggagaaaattagtagat

SEQ ID NO: 6 - DNA, 12 bp, Artificial sequence
  pHIV protease gene codon 10 probe
gagacaacgggt

SEQ ID NO: 7 - DNA, 12 bp, Artificial sequence
  pHIV protease gene codon 10 HNA (Hexitol Nucleic Acid) probe
gagacaacgggt

SEQ ID NO: 8 - DNA, 12 bp, Artificial sequence
  pHIV protease gene codon 10 ANA (Altritol Nucleic Acid)probe
gagacaacgggt

SEQ ID NO: 9 - DNA, 12 bp, Artificial sequence
  pHIV protease gene codon 36 probe
aaatttatgtct

SEQ ID NO: 10 - DNA, 12 bp, Artificial sequence
  pHIV protease gene codon 36 HNA (Hexitol Nucleic Acid) probe
aaatttatgtct

SEQ ID NO: 11 - DNA, 12 bp, Artificial sequence
  pHIV protease gene codon 36 ANA (Altritol Nucleic Acid) probe
aaatttatgtct

SEQ ID NO: 12 - DNA, 12 bp, Artificial sequence
  pHIV protease gene codon 54 probe
tttgacaaaacc

SEQ ID NO: 13 - DNA, 12 bp, Artificial sequence
  pHIV protease gene codon 54 HNA (Hexitol Nucleic Acid) probe
tttgacaaaacc

SEQ ID NO: 14 - DNA, 12 bp, Artificial sequence
  pHIV protease gene codon 54 ANA (Altritol Nucleic Acid) probe
tttgacaaaacc

SEQ ID NO: 15 - DNA, 12 bp, Artificial sequence
  pHIV reverse transcriptase codon 74 probe
ctactacttttc

SEQ ID NO: 16 - DNA, 12 bp, Artificial sequence
  pHIV reverse transcriptase codon 74 HNA (Hexitol Nucleic Acid)probe
ctactacttttc

SEQ ID NO: 17 - DNA, 12 bp, Artificial sequence
  pHIV reverse transcriptase codon 74 ANA (Altritol Nucleic Acid) probe
ctactacttttc

SEQ ID NO: 18 - DNA, 12 bp, Artificial sequence
  antisense probe HIV protease codon 54
tttgacaaaacc

SEQ ID NO: 19 - DNA, 12 bp, Artificial sequence
  antisense probe HIV protease codon 36
aaatttaugtct

SEQ ID NO: 20 - DNA, 12 bp, Artificial sequence
  antisense probe HIV protease codon 10
gagacaacgggt

SEQ ID NO: 21 - DNA, 12 bp, Artificial sequence
  antisense probe HIV reverse trancriptase codon 74
ctactacttttc

SEQ ID NO: 22 - DNA, 12 bp, Artificial sequence
  antisense HIV protease codon 54
tttgacaaaacc

SEQ ID NO: 23 - DNA, 12 bp, Artificial sequence
  antisense HIV protease codon 54
tttgacaaaacc

SEQ ID NO: 24 - DNA, 12 bp, Artificial sequence
  antisense HIV protease codon 54
tttgacaaaacc

SEQ ID NO: 25 - DNA, 12 bp, Artificial sequence
  sense HIV protease codon 54
aaactgttttgg

SEQ ID NO: 26 - DNA, 12 bp, Artificial sequence
  sense HIV protease codon 54
aaactgttttgg

SEQ ID NO: 27 - DNA, 12 bp, Artificial sequence
  sense HIV protease codon 54
aaactattttgg

SEQ ID NO: 28 - DNA, 12 bp, Artificial sequence
  antisense HIV protease codon 10
gagacaacgggt

SEQ ID NO: 29 - DNA, 12 bp, Artificial sequence
  antisense HIV protease codon 10
gagacaacgggt

SEQ ID NO: 30 - DNA, 12 bp, Artificial sequence
  antisense HIV protease codon 10
gagacaacgggt

SEQ ID NO: 31 - DNA, 12 bp, Artificial sequence
  sense HIV protease codon 10
ctctgttgccca

SEQ ID NO: 32 - DNA, 12 bp, Artificial sequence
  sense HIV protease codon 10
ctctgttgccca

SEQ ID NO: 33 - DNA, 12 bp, Artificial sequence
  sense HIV protease codon 10
ctctgctcccca

SEQ ID NO: 34 - DNA, 12 bp, Artificial sequence
  sense HIV protease codon 10
ctctgctgccca

SEQ ID NO: 35 - DNA, 12 bp, Artificial sequence
  sense HIV protease codon 10
ctctgctcccca

SEQ ID NO: 36 - RNA, 12 nt, Artificial sequence
  sense HIV protease codon 10
cucuguugccca

SEQ ID NO: 37 - RNA, 12 nt, Artificial sequence
  sense HIV protease codon 10
cucugcucccca

SEQ ID NO: 38 - DNA, 12 bp, Artificial sequence
  antisense HIV reverse transcriptase codon 74
ctactacttttc

SEQ ID NO: 39 - DNA, 12 bp, Artificial sequence
  antisense HIV reverse transcriptase codon 74
ctactacttttc

SEQ ID NO: 40 - DNA, 12 bp, Artificial sequence
  antisense HIV reverse transcriptase codon 74
ctactacttttc

SEQ ID NO: 41 - DNA, 12 bp, Artificial sequence
  sense HIV reverse transcriptase codon 74
catgatgaaaag

SEQ ID NO: 42 - DNA, 12 bp, Artificial sequence
  sense HIV reverse transcriptase codon 74
catgatgaaaag

SEQ ID NO: 43 - DNA, 12 bp, Artificial sequence
  sense HIV reverse transcriptase codon 74
catgattaaaag

SEQ ID NO: 44 - RNA, 12 nt, Artificial sequence
  sense HIV reverse transcriptase codon 74
caugaugaaaag

SEQ ID NO: 45 - RNA, 12 nt, Artificial sequence
  sense HIV reverse transcriptase codon 74
caugauuaaaag

SEQ ID NO: 46 - DNA, 12 bp, Artificial sequence
  antisense HIV protease codon 36
aaatttatgtct

SEQ ID NO: 47 - DNA, 12 bp, Artificial sequence
  antisense HIV protease codon 36
aaatttatgtct

SEQ ID NO: 48 - DNA, 12 bp, Artificial sequence
  antisense HIV protease codon 36
aaatttatgtct

SEQ ID NO: 49 - DNA, 12 bp, Artificial sequence
  sense HIV protease codon 36
tttaaatacaga

SEQ ID NO: 50 - DNA, 12 bp, Artificial sequence
  sense HIV protease codon 36
tttaaatacaga

SEQ ID NO: 51 - DNA, 12 bp, Artificial sequence
  sense HIV protease codon 36
tttaagtacaga